(19) United States
(12) Patent Application Publication
(10) Pub. No.: US 2023/0374419 A1
(43) Pub. Date: Nov. 23, 2023

(54) NEUTRAL SOLID AND LIQUID ENZYMATIC RINSE AID

(71) Applicant: ECOLAB USA INC., Saint Paul, MN (US)

(72) Inventors: Wendy Lo, Saint Paul, MN (US); Erik C. Olson, Saint Paul, MN (US); Nathan D. Peitersen, Saint Paul, MN (US); Derrick Anderson, Saint Paul, MN (US)

(21) Appl. No.: 18/320,301

(22) Filed: May 19, 2023

Related U.S. Application Data
(60) Provisional application No. 63/365,034, filed on May 20, 2022.

(51) Int. Cl. C11D 3/386; C11D 1/825

(52) U.S. Cl. CPC C11D 3/386; C11D 1/825

(57) ABSTRACT

Solid and liquid enzymatic rinse aid compositions for ware washing applications are disclosed and provide soil removal during the rinse cycle. In particular, compositions and methods of using the same provide enhanced soil removal in a rinse step of ware washing.

### CROSS-REFERENCE TO RELATED APPLICATIONS

This application claims priority under 35 U.S.C. § 119 to provisional application Ser. No. 63/365,034, filed May 20, 2022, herein incorporated by reference in its entirety.

### TECHNICAL FIELD

The disclosure relates to solid or liquid enzymatic rinse aid compositions for ware washing applications to beneficially provide soil removal during the rinse cycle. In particular, compositions and methods of using the same provide enhanced soil removal in a rinse step of ware washing.

### BACKGROUND

Alkaline detergents are used extensively to clean articles in both consumer and industrial ware wash machines. Alkaline detergents are extensively used because of their ability to remove and emulsify fatty, oily, hydrophobic soils. However, alkaline detergents have the disadvantage of requiring a rinse aid to prevent the formation of films on glass and other substrate surfaces contacted by the alkaline detergent. Filming is caused in part by using alkaline detergents in combination with certain water types (including hard water), and water temperatures. A solution to the generation of hard water films has been to employ rinse aids to remove such films. Additionally, rinse aids are used in a rinse cycle following the wash cycle to enhance drying time, as well as reduce any cleaning imperfections.

Conventional machine warewash in the industrial space utilizes two products to achieve clean, dry, spot free ware: detergent and rinse aid. These two products are distinct in that typically the detergent is dispensed in the wash step and the rinse aid during the rinse step. However, there has been significant effort to provide 2-in-1 formulations for both alkaline detergents with a combined rinse aid formulation. Despite the many products available for industrial and consumer use in ware washing, there remains a need for alternative, effective rinse aid compositions, boosters and/or detergent and rinse aid systems that provide enhanced cleaning results.

Thus, there exists a need in the art for improved methods of cleaning and rinsing ware.

It is therefore an object of this disclosure to provide rinse aid compositions, including stable liquids and solids, comprising a protease enzyme to enhance soil removal during a rinse cycle.

It is a further object of the disclosure to provide systems for employing the rinse aid compositions comprising a protease enzyme to enhance soil removal during a rinse cycle.

It is another object of this disclosure to provide enhanced method of cleaning and rinsing ware.

Other objects, embodiments and advantages of this disclosure will be apparent to one skilled in the art in view of the following disclosure, the drawings, and the appended claims.

### BRIEF SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide rinse aid compositions comprising at least one enzyme comprising a protease; a phosphonate, chelant, and/or non-phosphorus stabilizing agent; at least one nonionic surfactant; and water and at least one solvent for a neutral liquid composition; or at least one solidification agent for a neutral solid composition.

It is a further object, feature, and/or advantage of the present disclosure to provide methods of cleaning and rinsing ware comprising contacting the ware with an alkaline detergent composition or a 2-in-1 detergent and rinse aid composition and thereafter contacting the ware with a rinse aid composition as described according to the embodiments of the disclosure or an enzyme booster composition comprising a protease enzyme; or contacting the ware with a detergent and rinse aid system according to the embodiments of the disclosure; and rinsing the ware with water; wherein the use of the rinse aid composition or the detergent and rinse aid system containing a protease enzyme provide improved soil removal during the rinse step compared to a rinse aid composition or a detergent and rinse aid system that does not include the protease enzyme.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows images of glass tumblers, pre and post stain, treated with rinse aid formulations over 50 cycles of testing.

FIG. 2 shows images of ceramic coupons, pre and post stain, treated with rinse aid formulations over 10 cycles of testing.

FIG. 3 shows images of glass tumblers, pre and post stain, treated with various rinse aid formulations over 50 cycles of testing.

FIG. 4 shows images of glass tumblers, pre and post stain, treated with various rinse aid formulations over 50 cycles of testing.

FIG. 5 shows images of glass tumblers, pre and post stain, treated with rinse aid formulations over 50 cycles of testing.

FIG. 6 shows images of glass tumblers, pre and post stain, treated with rinse aid formulations over 50 cycles of testing.

FIG. 7 shows images of glass plates, metal plates, ceramic plates, and ceramic coupons post stain, treated with rinse aid formulations over 10 cycles of testing.

FIG. 8 shows images of glass plates, metal plates, ceramic plates, and ceramic coupons post stain, treated with rinse aid formulations over 10 cycles of testing.

FIG. 9 shows images of ceramic coupons post stain, treated with rinse aid formulations over 50 cycles of testing.

FIG. 10 shows images of glass tumblers, post cleaning, treated with various rinse aid formulations over 100 cycles of testing.

FIG. 11 is a graph showing the formea concentrate stability and retained activity of the composition in room temperature, 40° C., and 50° C. over 8 weeks.

FIG. 12 is a graph showing the esperase concentrate stability and retained activity of the composition in room temperature, 40° C., and 50° C. over 8 weeks.

FIG. 13 is a graph showing the sump stability and retained activity of formea and esperase compositions with and without soil over 120 minutes.

FIG. 14 is a graph showing the 10% sump stability and retained activity of SRA14 composition in room temperature and 40° C. over 6 weeks.

FIG. 15 is a graph showing the sump stability and retained activity of amylase compositions and an inline no enzyme detergent composition with and without soil over 120 minutes.

FIG. 16 is a graph showing the sump stability and retained activity of protease compositions and an inline no enzyme detergent composition with and without soil over 120 minutes.

FIG. 17 is a graph showing the percent removal of a cornstarch solution on melamine tiles treated with various amounts of amylase rinse aid formulations over 20 cycles of testing.

FIG. 18 is a graph showing the sump stability of 5% esperase composition with 2000 ppm of soil and no soil over 120 minutes.

FIG. 19 is a graph showing the sump stability of 2% formea composition with 2000 ppm of soil and no soil over 120 minutes.

FIG. 20 is a graph showing the concentrate stability of 5% esperase at room temperature, 40° C., and 50° C. over 8 weeks.

FIG. 21 is a graph showing the concentrate stability of 2% formea at room temperature, 40° C., and 50° C. over 8 weeks.

FIG. 22 is a graph showing the concentrate stability of 2% formea and 13.32% glycerin at room temperature, 40° C., and 50° C. over 8 weeks.

FIG. 23 is a graph showing the concentrate stability of 2% formea and 20% glycerin at room temperature, 40° C., and 50° C. over 2 weeks.

FIG. 24 is a graph showing the concentrate stability of 2% formea and 25% glycerin at room temperature, 40° C., and 50° C. over 2 weeks.

FIG. 25 is a graph showing the concentrate stability of 2% formea and 30% glycerin at room temperature, 40° C., and 50° C. over 2 weeks.

FIG. 26 is a graph showing the concentrate stability of 5% esperase and 13.32% glycerin at room temperature, 40° C., and 50° C. over 8 weeks.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the disclosure. An artisan of ordinary skill in the art need not view, within isolated figure(s), the near infinite number of distinct permutations of features described in the following detailed description to facilitate an understanding of the present disclosure.

### DETAILED DESCRIPTION

The present disclosure is not to be limited to that described herein, which can vary and are understood by skilled artisans. No features shown or described are essential to permit basic operation of the present disclosure unless otherwise indicated. It has been surprisingly found that stabilized liquid and solid rinse aid compositions containing an enzyme can provide enhanced soil removal during a rinse cycle.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, mass, volume, time, temperature, pH, and log count of bacteria or viruses. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, acylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

As used herein, the term “exemplary” refers to an example, an instance, or an illustration, and does not indicate a most preferred embodiment unless otherwise stated.

As used herein, the term “free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “generally” encompasses both “about” and “substantially.”

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The term “generally recognized as safe” or “GRAS,” as used herein refers to components classified by the Food and Drug Administration as safe for direct human food consumption or as an ingredient based upon current good manufacturing practice conditions of use, as defined for example in 21 C.F.R. Chapter 1, § 170.38 and/or 570.38.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

As used herein, the term “solid” refers to a state of matter known to those of skill in the art. A solid may be of crystalline, amorphous form, or a mixture thereof. A solid composition can include a single compound or a mixture of compounds. A solid may be a mixture of two or more different solids. A solid may be aggregates of particles, each of which has a size of a few, a few tens, a few hundreds of micrometers or nanometers. A solid may be a powder of one or more compounds. As used herein, a solid composition can include a solid such as a powder, a flake, a granule, a pellet, a tablet, a lozenge, a puck, a briquette, a brick, a solid block, or another solid form known to those of skill in the art. It should be understood that the term “solid rinse aid” refers to the state of the rinse aid composition under the expected conditions of storage and use of the solid rinse aid composition. In general, it is expected that the composition will remain a solid when provided at a temperature of a room temperature up to about 120° F., including maintaining dimensional stability

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” or “surface active agent” refers to an organic chemical that when added to a liquid changes the properties of that liquid at a surface. Surfactants are compounds that contain a lipophilic segment and a hydrophilic segment, which when added to water or solvents, reduces the surface tension of the system. An “extended chain surfactant” is a surfactant having an intermediate polarity linking chain, such as a block of poly-propylene oxide, or a block of poly-ethylene oxide, or a block of poly-butylene oxide or a mixture thereof inserted between the surfactant's conventional lipophilic segment and hydrophilic segment.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the disclosure include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Compositions

According to embodiments, the rinse aid compositions can be liquid or solid compositions. The rinse aid compositions include enzyme, stabilizer(s) (e.g. phosphonate), nonionic surfactant(s), water and/or solidification agents, and any number of additional functional ingredients. Exemplary rinse aid compositions are shown in Table 1 for liquid formulations and Table 2 for solid formulations in weight percentage. While the components may have a percent actives of 100%, it is noted that Table 1 does not recite the percent actives of the components, but rather, recites the total weight percentage of the raw materials (i.e. active concentration plus inert ingredients).

TABLE 1
(liquid formulations)

| | First | Second | Third |
|---|---|---|---|
| | Exemplary | Exemplary | Exemplary |
| Material | Range wt.-% | Range wt.-% | Range wt.-% |
| Enzyme | 0.1-10 | 0.1-5 | 1-5 |
| Stabilizers (e.g. | 0-10 | 0-5 | 0-3 |
| phosphonates, | | | |
| chelants, etc.) | | | |
| Surfactant(s) | 1-20 | 1-15 | 1-10 |
| Water | 10-90 | 20-90 | 20-70 |
| Additional Functional | 0-60 | 0-50 | 0.1-50 |
| Ingredients | | | |

TABLE 2
(solid formulations)

| | First | Second | Third |
|---|---|---|---|
| | Exemplary | Exemplary | Exemplary |
| Material | Range wt.-% | Range wt.-% | Range wt.-% |
| Enzyme | 0.1-10 | 1-10 | 2-10 |
| Stabilizers (e.g. | 1-10 | 1-8 | 1-7 |
| phosphonates, | | | |
| chelants, etc.) | | | |
| Surfactant(s) | 1-50 | 2-50 | 5-50 |
| Neutral Solidification | 10-90 | 10-80 | 10-70 |
| Agent(s) | | | |
| Additional Functional | 0-60 | 0-50 | 0.1-50 |
| Ingredients | | | |

### Form of the Compositions

The compositions may be provided as a liquid, e.g. as a use solution or as a concentrated liquid. The compositions of the present application may further be provided as a solid, e.g. as a stabilized solid composition. A solid composition can be provided as a pressed solid block, a cast solid block, an extruded pellet or block, or a tablet so that one or a plurality of the solids will be available in a package having a size of at least about 1 gram, at least about 10 grams, at least about 100 grams, or at least about 1,000 grams. A solid composition may be provided in the form of a unit dose. A unit dose refers to a solid composition unit sized so that the entire unit is used during a single washing cycle. When the solid composition is provided as a unit dose, it is preferably provided as a pressed solid having a size of between about 1 gram and about 50 grams. Alternatively, a pressed solid, a cast solid, an extruded pellet, or a tablet may be made into a variety of sizes. An extruded, cast, or pressed solid may have a weight of about 100 grams or greater. According to embodiments, the solid composition is preferably a pressed or extruded solid.

In some situations, the methods of making pressed blocks reduce or eliminate water from the composition. Preferably, the compositions are formed using components in an anhydrous form. In some other situations, compositions have a water content of less than about 10% by weight, less than about 5% by weight, less than about 1% by weight, less than about 0.1% by weight, less than about 0.05% by weight, and most preferably free of water (e.g. dried). In an aspect, the dried composition may be in the form of granules. On contrast, cast or extruded solid detergent blocks can often have from about 20 to about 40 wt-% water.

### Concentrates and Use Compositions

The rinse aid compositions can be provided as a concentrate. The term “concentrate” refers to a relatively concentrated form of the composition that can be diluted with a diluent to form a use composition. An exemplary diluent that can be used to dilute the concentrate to form the use composition is water. In general, the use composition refers to the composition that contacts an article to provide a desired action. For example, a warewashing rinse aid composition that is provided as a use composition can contact ware for cleaning the ware. In addition, the concentrate or the diluted concentrate can be provided as the use composition. For example, the concentrate can be referred to as the use composition when it is applied to an article without dilution. In many situations, it is expected that the concentrate will be diluted to provide a use composition that is then applied to an article.

In another aspect, a use solution is generated from the compositions of Table 1 or Table 2 having a range of dilution from about 1:10 to 1:10,000. In an aspect of the present application, a use solution of the composition has between about 1 ppm to about 500 ppm enzyme. In a more preferred embodiment a use solution of the composition has between about 1 ppm to about 40 ppm, or preferably between about 1 ppm to about 30 ppm enzyme.

pH

The rinse aid compositions are preferably neutral compositions to provide stability for the enzyme(s) which are most stable in pH conditions between about 6 and about 10. In an embodiment, the compositions have a use solution pH between about 6 and about 9, or preferably between about 7 and about 9, or most preferably about 7. The pH of the concentrate liquid composition, as shown in Table 1, is between about 7 and about 9 to provide the neutral use conditions. In addition, without being limited according to the disclosure, all ranges recited are inclusive of the numbers defining the range and include each integer within the defined range.

### Stability

Beneficially, the liquid rinse aid compositions comprising an enzyme demonstrate shelf stability, such that they can be stored for at least about 2 weeks, preferably for at least about 4 weeks, more preferably at least about 6 weeks, most preferably at least about 8 weeks, while retaining efficacy of the components and such that the liquid composition does not separate during storage. Further, the liquid rinse aid compositions demonstrate shelf stability, such that they can be stored at temperatures greater than room temperature, preferably at least about 40° C., more preferably at least about 45° C., most preferably at least about 50° C., while retaining efficacy of the components and such that the liquid composition does not separate during storage.

In another aspect, the rinse aid compositions maintain enzyme stability in the liquid and solid compositions over the described time and temperature conditions, as measured by at least about 50%, at least about 55%, at least about 60%, at least about 65%, at least about 70%, at least about 75%, at least about 80%, at least about 85%, at least about 90%, or at least about 95% enzymatic activity retained over a defined temperature and pH condition.

### Enzymes

The rinse aid compositions include one or more enzymes, which can provide desirable activity for removal of soils, including protein-based, or carbohydrate-based soils from substrates such as wares including flatware, cups and bowls, and pots and pans. Enzymes suitable for the composition can act by degrading or altering one or more types of soil residues encountered on a surface thus removing the soil or making the soil more removable by a surfactant or other component of the cleaning composition. Both degradation and alteration of soil residues can improve soil removal (i.e. detergency) by reducing the physicochemical forces which bind the soil to the surface or textile being cleaned, i.e. the soil becomes more water soluble. For example, one or more proteases can cleave complex, macromolecular protein structures present in soil residues into simpler short chain molecules which are, of themselves, more readily desorbed from surfaces, solubilized, or otherwise more easily removed by detersive solutions containing said proteases.

Preferred enzymes include, amylases, cellulases, lipases, proteases, and combinations of the same. Most preferably, the enzyme comprises two or more of a protease, an amylase, and a lipase.

Amylases

Any amylase or mixture of amylases, from any source, can be used in the enzymatic detergent compositions, provided that the selected enzyme is stable in the desired pH range (between about 6 and about 9). For example, the amylase enzymes can be derived from a plant, an animal, or a microorganism such as a yeast, a mold, or a bacterium. Preferred amylase enzymes include, but are not limited to, those derived from a Bacillus, such as B. licheniformis, B. amyloliquefaciens, B. subtilis, or B. stearothermophilus. Amylase enzymes derived from B. subtilis are most preferred. The amylase can be purified or a component of a microbial extract, and either wild type or variant (either chemical or recombinant). Preferred amylases are commercially available under the trade name Stainzyme® available from Novozymes.

Lipases

Any lipase or mixture of lipases, from any source, can be used in the enzymatic detergent compositions, provided that the selected enzyme is stable in the desired pH range (between about 6 and about 9). For example, the lipase enzymes can be derived from a plant, an animal, or a microorganism such as a fungus or a bacterium. Preferred protease enzymes include, but are not limited to, the enzymes derived from a Pseudomonas, such as Pseudomonas stutzeri ATCC 19.154, or from a Humicola, such as Humicola lanuginosa (typically produced recombinantly in Aspergillus oryzae). The lipase can be purified or a component of a microbial extract, and either wild type or variant (either chemical or recombinant).

Proteases

Any protease or mixture of proteases, from any source, can be used in the enzymatic detergent compositions, provided that the selected enzyme is stable in the desired pH range (between about 6 and about 9). For example, the protease enzymes can be derived from a plant, an animal, or a microorganism such as a yeast, a mold, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant). Exemplary proteases are commercially available under the following trade names Alcalase®, Blaze®, Savinase®, Esperase®, and Progress UNO™ (also sold under the name Everis DUO™) each available from Novozymes.

Cellulases

Any cellulase or mixture of cellulases, from any source, can be used in the enzymatic detergent compositions, provided that the selected enzyme is stable in the desired pH range (between about 6 and about 9). For example, the cellulase enzymes can be derived from a plant, an animal, or a microorganism such as a fungus or a bacterium. Preferred cellulase enzymes include, but are not limited to, those derived from Humicola insolens, Humicola strain DSM1800, or a cellulase 212-producing fungus belonging to the genus Aeromonas and those extracted from the hepatopancreas of a marine mollusk, Dolabella Auricula Solander. The cellulase can be purified or a component of a microbial extract, and either wild type or variant (either chemical or recombinant).

Other Enzymes

The enzymatic detergent compositions can comprise additional enzymes in addition to the foregoing. Additional suitable enzymes can include, but are not limited to, cutinases, peroxidases, gluconases, or mixtures thereof.

In embodiments, preferred enzymes include a protease enzyme, or a mixture thereof of any suitable origin, such as vegetable, animal, bacterial, fungal or yeast origin. One or more (e.g., several) of the enzymes may be wild-type proteins, recombinant proteins, or a combination of wild-type proteins and recombinant proteins. For example, one or more (e.g., several) enzymes may be native proteins of a cell, which is used as a host cell to express recombinantly the enzyme composition. The enzyme composition may also be a fermentation broth formulation or a cell composition. A valuable reference on enzymes, which is incorporated herein by reference is “Industrial Enzymes,” Scott, D., in Kirk-Othmer Encyclopedia of Chemical Technology, 3rd Edition, (editors Grayson, M. and EcKroth, D.) Vol. 9, pp. 173-224, John Wiley & Sons, New York, 1980.

Preferred selections are influenced by factors such as pH-activity and/or stability optima, thermostability, and stability to pH, detergents, builders, and the like. In this respect bacterial or fungal enzymes are preferred, such as bacterial esperases and proteases. In some embodiments preferably the enzyme is a protease, including an esperase, or a combination thereof.

In an embodiment the enzyme is a protease. Exemplary subclasses of protease include alcalase, an esperase, a savinase, and a neutrase. In an embodiment the protease is an esperase, and does not include (is substantially-free or free of) any alcalase, savinate, and/or neutrase. In further embodiments the esperase is a subtilisin protease.

Any protease or mixture of proteases, from any source, can be used in the compositions, provided that the selected enzyme is stable in the desired pH range (between about 6 and about 9). For example, the protease enzymes can be derived from a plant, an animal, or a microorganism such as a yeast, a mold, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant). Exemplary proteases are commercially available under the following trade names Excellase™, Properase™, Purafect™, Purafect™ Prime, Purafect™ Ox each available from Genencor and Alcalase®, Blaze®, Evity®, Savinase®, Esperase®, Liquinase™, Ovozyme™, Everlase™, Release™, Polarzyme™ Coronase™, and Progress UNO™ (also sold under the name Everis DUO™) each available from Novozymes.

In embodiments, the enzyme is preferably one or more (e.g., several) enzymes comprising, consisting essentially of, or consisting of an esperase, or more broadly a protease. The enzyme may further be obtained commercially in a solid form (i.e., puck, powder, etc.) or liquid formulation. Commercially-available enzymes are often combined with stabilizers, buffers, cofactors and/or inert vehicles. The actual active enzyme content depends upon the method of manufacture, which is well known to a skilled artisan and such methods of manufacture are not critical to the present disclosure. In any of the embodiments the enzyme is homogenously dispersed in the composition.

In embodiments an enzyme is included in a liquid composition from about 0.1 wt-% to about 10 wt-%, from about 0.1 wt-% to about 5 wt-%, from about 1 wt-% to about 5 wt-%, from about 2 wt-% to about 5 wt-%, from about 2 wt-% to about 4 wt-%, or from about 1 wt-% to about 3 wt-% enzyme(s). In addition, without being limited according to the disclosure, all ranges recited are inclusive of the numbers defining the range and include each integer within the defined range.

In embodiments an enzyme is included in a solid composition from about 0.1 wt-% to about 10 wt-%, from about 1 wt-% to about 10 wt-%, from about 2 wt-% to about 10 wt-%, from about 2 wt-% to about 9 wt-%, from about 2 wt-% to about 8 wt-%, or from about 3 wt-% to about 6 wt-% enzyme(s). In addition, without being limited according to the disclosure, all ranges recited are inclusive of the numbers defining the range and include each integer within the defined range.

### Additional Enzymes

In additional embodiments a first enzyme and an additional or alternative enzyme can be included in the rinse aid compositions or employed in a booster composition. For example, enzymes can include amylase, lipase, cellulase, cutinase, gluconase, peroxidase, mannanase, pectinase, peptidase and/or mixtures thereof. A rinse aid composition or booster composition may employ more than one enzyme, from any suitable origin, such as vegetable, animal, bacterial, fungal or yeast origin.

In embodiments an enzyme is included in a liquid composition from about 0.1 wt-% to about 10 wt-%, from about 0.1 wt-% to about 5 wt-%, from about 1 wt-% to about 5 wt-%, from about 2 wt-% to about 5 wt-%, from about 2 wt-% to about 4 wt-%, or from about 1 wt-% to about 3 wt-% enzyme(s). In addition, without being limited according to the disclosure, all ranges recited are inclusive of the numbers defining the range and include each integer within the defined range.

In embodiments an enzyme is included in a solid composition from about 0.1 wt-% to about 10 wt-%, from about 1 wt-% to about 10 wt-%, from about 2 wt-% to about 10 wt-%, from about 2 wt-% to about 9 wt-%, from about 2 wt-% to about 8 wt-%, or from about 3 wt-% to about 6 wt-% enzyme(s). In addition, without being limited according to the disclosure, all ranges recited are inclusive of the numbers defining the range and include each integer within the defined range.

### Stabilizing Agents

The rinse aid compositions include at least one enzyme stabilizing agent. In embodiments, phosphonates are preferred as an enzyme stabilizer. In other embodiments, a chelant (e.g. polycarboxylates) and/or non-phosphorus stabilizing agent is included in the rinse aid composition either in addition to the phosphonate or in place of the phosphonate. In some embodiments, phosphonates and/or chelants that do not provide enzyme stabilizing can be incorporated as water conditioning agents.

### Phosphonate

The rinse aid compositions can include a phosphonate as an enzyme stabilizer. Examples of phosphonates include, but are not limited to: 2-phosphonobutane-1,2,4-tricarboxylic acid (PBTC), 1-hydroxyethane-1,1-diphosphonic acid (HEDP), CH₂C(OH)[PO(OH)₂]₂; aminotri(methylenephosphonic acid), N[CH₂PO(OH)₂]₃; aminotri(methylenephosphonate), sodium salt (ATMP), N[CH₂PO(ONa)₂]₃; 2-hydroxyethyliminobis(methylenephosphonic acid), HOCH₂CH₂N[CH₂PO(OH)₂]₂; diethylenetriaminepenta(methylenephosphonic acid), (HO)₂POCH₂N[CH₂CH₂N[CH₂PO(OH)₂]₂]₂; diethylenetriaminepenta(methylenephosphonate), sodium salt (DTPMP), C₉H₍₂₈₋ₓ₎N₃NaₓO₁₅P₅ (x=7); hexamethylenediamine(tetramethylenephosphonate), potassium salt, C₁₀H₍₂₈₋ₓ₎N₂KxO₁₂P₄ (x=6); bis(hexamethylene)triamine(pentamethylenephosphonic acid), (HO₂)POCH₂N[(CH₂)₂N[CH₂PO(OH)₂]₂]₂; and phosphorus acid, H₃PO₃. A preferred phosphonate is aminotri(methylenephosphonate), sodium salt (ATMP), hydroxyethane-1,1-diphosphonic acid (HEDP), 2-phosphonobutane-1,2,4-tricarboxylic acid (PBTC), or combinations thereof.

In embodiments employing a phosphonate the composition preferably includes from about 0.1 wt-% to about 10 wt-%, from about 1 wt-% to about 10 wt-%, from about 1 wt-% to about 9 wt-%, from about 1 wt-% to about 8 wt-%, or from about 1 wt-% to about 7 wt-% phosphonate. In addition, without being limited according to the disclosure, all ranges recited are inclusive of the numbers defining the range and include each integer within the defined range.

### Chelants

The compositions can optionally comprise a chelant (or a sequestrant or builder) in addition to the phosphonate or in place of a phosphonate in the rinse aid composition.

In addition to aminocarboxylates, which contain little or no NTA, water conditioning polymers can be used as non-phosphorous containing builders. Polycarboxylic acid polymer chelants are non-phosphorus containing chelants. Polycarboxylates include those chelant polymers having pendant carboxylate (—CO₂—) groups such as polyacrylic acid homopolymers, polymaleic acid homopolymers, maleic/olefin copolymers, sulfonated copolymers or terpolymers, acrylic/maleic copolymers or terpolymers polymethacrylic acid homopolymers, polymethacrylic acid copolymers or terpolymers, acrylic acid-methacrylic acid copolymers, hydrolyzed polyacrylamides, hydrolyzed polymethacrylamides, hydrolyzed polyamide-methacrylamide copolymers, hydrolyzed polyacrylonitriles, hydrolyzed polymethacrylonitriles, hydrolyzed acrylonitrile-methacrylonitrile copolymers and combinations thereof. For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein. These materials may also be used at sub-stoichiometric levels to function as crystal modifiers.

Polycarboxylic acid polymer chelants can include polyacrylic acid homopolymers and polymaleic acid homopolymers, and polymers modified by a fatty acid end group. The polyacrylic acid homopolymers can contains a polymerization unit derived from the monomer selected from the group consisting of acrylic acid, methacrylic acid, methyl acrylate, methyl methacrylate, ethyl acrylate, ethyl methacrylate, butyl acrylate, butyl methacrylate, iso-butyl acrylate, iso-butyl methacrylate, iso-octyl acrylate, iso-octyl methacrylate, cyclohexyl acrylate, cyclohexyl methacrylate, glycidyl acrylate, glycidyl methacrylate, hydroxyethyl acrylate, hydroxypropyl acrylate, 2-hydroxyethyl acrylate, 2-hydroxyethyl methacrylate, 2-hydroxypropyl acrylate, 2-hydroxypropyl methacrylate. and hydroxypropyl methacrylate and a mixture thereof, among which acrylic acid. methacrylic acid, methyl acrylate, methyl methacrylate, butyl acrylate, butyl methacrylate, iso-butyl acrylate, iso-butyl methacrylate, hydroxyethyl acrylate, 2-hydroxyethyl acrylate, 2-hydroxyethyl methacrylate, 2-hydroxypropyl acrylate, and 2-hydroxypropyl methacrylate, and a mixture thereof are preferred. Exemplary polyacrylic acid homopolymers include those with a molecular weight between about 500-100,000 g/mol, or between about 1,000-50,000 g/mol, or between about 1,000-25,000 g/mol. Exemplary suitable commercially available polyacrylic acid polymers include Acusol 445N (a fully neutralized homopolymer of acrylic acid), Acusol 448 and Acusol 944 available from Dow Chemical. Exemplary suitable commercially available polymaleic acid chelants/water conditioners include, for example, Belclene 200, commercially available from BWA.

In additional embodiments, mixtures of acrylic acid homopolymers and/or polymers including acrylate monomers can be employed.

Exemplary aminocarboxylic acid chelants containing little or no NTA include, but are not limited to: N-hydroxyethylaminodiacetic acid, ethylenediaminetetraacetic acid (EDTA), hydroxyethylenediaminetetraacetic acid, diethylenetriaminepentaacetic acid, N-hydroxyethyl-ethylenediaminetriacetic acid (HEDTA), diethylenetriaminepentaacetic acid (DTPA), methylglycinediacetic acid (MGDA), glutamic acid-N,N-diacetic acid (GLDA), ethylenediaminesuccinic acid (EDDS), 2-hydroxyethyliminodiacetic acid (HEIDA), iminodisuccinic acid (IDS), 3-hydroxy-2-T-iminodisuccinic acid (HIDS) and other similar acids or salts thereof having an amino group with a carboxylic acid substituent. In one embodiment, however, the composition is free of aminocarboxylates.

Additional exemplary chelants containing little or no NTA include small molecule organic water conditioning agents include, but are not limited to: sodium gluconate, sodium glucoheptonate, N-hydroxyethylenediaminetriacetic acid (HEDTA), ethylenediaminetetraacetic acid (EDTA), nitrilotriacetic acid (NTA), diethylenetriaminepentaacetic acid (DTPA), ethylenediaminetetraproprionic acid, triethylenetetraaminehexaacetic acid (TTHA), and the respective alkali metal, ammonium and substituted ammonium salts thereof, ethylenediaminetetraacetic acid tetrasodium salt (EDTA), nitrilotriacetic acid trisodium salt (NTA), ethanoldiglycine disodium salt (EDG), diethanolglycine sodium-salt (DEG), and 1,3-propylenediaminetetraacetic acid (PDTA), dicarboxymethyl glutamic acid tetrasodium salt (GLDA), methylglycine-N—N-diacetic acid trisodium salt (MGDA), and iminodisuccinate sodium salt (IDS). All of these are known and commercially available.

In embodiments where a chelant is included in the compositions in addition to the phosphonate, the one or more chelants can be present in an amount of between about 1 wt-% to about 40 wt-%, between about 1 wt-% to about 30 wt-%, between about 1 wt. % to about 20 wt-%, or between about 1 wt. % to about 10 wt-% of the composition. In addition, without being limited according to the disclosure, all ranges recited are inclusive of the numbers defining the range and include each integer within the defined range.

### Non-Phosphorus Stabilizing Agent

The compositions can optionally comprise a non-phosphorus stabilizing agent. The compositions can optionally comprise a stabilizing agent in addition to the phosphonate or in place of a phosphonate in the rinse aid composition.

Preferred stabilizing agents include, but are not limited to, calcium/magnesium ions, glycerol, polyethylene glycol 200, polyethylene glycol 400, propylene glycol, sucrose, and mixtures thereof. When the compositions include a stabilizing agent, it can be included in an amount that provides the desired level of stability to the composition.

Exemplary stabilizing agents for the compositions can include short-chain alkylbenzene sulfonates and/or alkyl naphthalene sulfonates. Exemplary short-chain alkylbenzene sulfonates and/or alkyl naphthalene sulfonates include, but are not limited to, sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, or sodium butylnaphthalene, a mixture thereof. In some embodiments, a short-chain alkylbenzene sulfonate and/or alkyl naphthalene sulfonate is a preferred stabilizer and carrier for liquid compositions comprising polymers, phosphonates and/or stabilizers, and nonionic surfactants.

The compositions can optionally comprise an enzyme stabilizing agent. Preferred enzyme stabilizers include amine oxides, alkyl polyglucosides, boron compounds or a calcium salts. More preferred, the enzyme stabilizers are amine oxides, such as Lauryl Dimethylamine Oxide. In some embodiments the compositions can have less than about 0.5 wt-% of borate-including ingredients, preferably less than about 0.1 wt-% of borate-including ingredients, most preferably less about 0.01 wt-% of borate-including ingredients. A most preferred embodiment is free of borate-including ingredients.

### Nonionic Surfactants

Nonionic surfactants are included in the rinse aid compositions. Nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties.

In some embodiments, the nonionic surfactant(s) is included in the liquid rinse aid composition at an amount of at least about 1 wt-% to about 20 wt-%, about 1 wt-% to about 15 wt-%, about 1 wt-% to about 10 wt-%, about 2 wt-% to about 10 wt-%, or about 2 wt-% to about 8 wt-%. In some embodiments, the nonionic surfactant(s) is included in the solid rinse aid composition at an amount of at least about 1 wt-% to about 60 wt-%, about 1 wt-% to about 50 wt-%, about 2 wt-% to about 50 wt-%, about 5 wt-% to about 10 wt-%, or about 10 wt-% to about 50 wt-%. In addition, without being limited according to the disclosure, all ranges recited are inclusive of the numbers defining the range and include each integer within the defined range.

Suitable nonionic surfactants include the following:

1. Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available under the trade names Pluronic® and Tetronic® manufactured by BASF Corp. Such compounds can include, by way of example, an EO/PO capped alkoxylated glycerol, wherein the EO groups are between 25 wt. % and 50 wt. % of the surfactant, more preferably between about 30 wt. % and about 50 wt. % of the surfactant. Pluronic® compounds are difunctional (two reactive hydrogens). Tetronic® compounds are tetra-functional block copolymers.

Some examples of polyoxyethylene-polyoxypropylene block copolymers include those having the following formulae:

(EO)x(PO)y(EO)x

(PO)y(EO)x(PO)y

(PO)_{y}(EO)ₓ(PO)_{y}(EO)ₓ(PO)_{y}

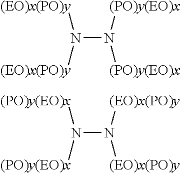

wherein EO represents an ethylene oxide group, PO represents a propylene oxide group, and x and y reflect the average molecular proportion of each alkylene oxide monomer in the overall block copolymer composition. In some embodiments, x is in the range of about 10 to about 130, y is in the range of about 15 to about 70, and x plus y is in the range of about 25 to about 200. It should be understood that each x and y in a molecule can be different. In some embodiments, the total polyoxyethylene component of the block copolymer can be in the range of at least about 20 mol-% of the block copolymer and in some embodiments, in the range of at least about 30 mol-% of the block copolymer. In some embodiments, the material can have a molecular weight greater than about 400, and in some embodiments, greater than about 500. For example, in some embodiments, the material can have a molecular weight in the range of about 500 to about 7000 or more, or in the range of about 950 to about 4000 or more, or in the range of about 1000 to about 3100 or more, or in the range of about 2100 to about 6700 or more.

Although the exemplary polyoxyethylene-polyoxypropylene block copolymer structures provided above have 3-8 blocks, it should be appreciated that the nonionic block copolymer surfactants can include more or less than 3 or 8 blocks. In addition, the nonionic block copolymer surfactants can include additional repeating units such as butylene oxide repeating units. Furthermore, suitable nonionic block copolymer surfactants can be characterized as heteric polyoxyethylene-polyoxypropylene block copolymers. Examples of polymeric compounds made from a sequential propoxylation and ethoxylation of initiator are commercially available under the trade names Pluronic® and Tetronic® manufactured by BASF Corp, in particular Pluronic® N-3, Pluronic® 25-R2, and others.

2. Condensation products of one mole of alkyl phenol wherein the alkyl chain, of straight chain or branched chain configuration, or of single or dual alkyl constituent, contains from 8 to 18 carbon atoms with from 3 to 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

3. Condensation products of one mole of a saturated or unsaturated, straight or branched chain alcohol having from 6 to 24 carbon atoms with from 3 to 50 moles of ethylene oxide. The alcohol moiety can consist of mixtures of alcohols in the above delineated carbon range or it can consist of an alcohol having a specific number of carbon atoms within this range. Examples of like commercial surfactants are available under the trade names Neodol® manufactured by Shell Chemical Co. and Alfonic® manufactured by Vista Chemical Co.

4. Condensation products of one mole of saturated or unsaturated, straight or branched chain carboxylic acid having from 8 to 18 carbon atoms with from 6 to 50 moles of ethylene oxide. The acid moiety can consist of mixtures of acids in the above defined carbon atom range or it can consist of an acid having a specific number of carbon atoms within the range. Examples of commercial compounds of this chemistry are available on the market under the trade names Nopalcol® manufactured by Henkel Corporation and Lipopeg® manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols can be used. All of these ester moieties have one or more reactive hydrogen sites on their molecule which can undergo further acylation or ethylene oxide (alkoxide) addition to control the hydrophilicity of these substances. Care must be exercised when adding these fatty ester or acylated carbohydrates to compositions containing amylase and/or lipase enzymes because of potential incompatibility.

Examples of nonionic low foaming surfactants include:

5. Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. These reverse Pluronics® are manufactured by BASF Corporation under the trade name Pluronic® R surfactants. Likewise, the Tetronic® R surfactants are produced by BASF Corporation by the sequential addition of ethylene oxide and propylene oxide to ethylenediamine.

6. Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

7. The alkylphenoxypolyethoxyalkanols of U.S. Pat. No. 2,903,486 issued Sep. 8, 1959 to Brown et al. and represented by the formula

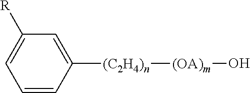

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkaline oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ(C₂H₄O)ₘH wherein Y is the residue of organic compound having from 1 to 6 carbon atoms and one reactive hydrogen atom, n has an average value of at least 6.4, as determined by hydroxyl number and m has a value such that the oxyethylene portion constitutes 10% to 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ(C₂H₄O)ₘH]ₓ wherein Y is the residue of an organic compound having from 2 to 6 carbon atoms and containing x reactive hydrogen atoms in which x has a value of at least 2, n has a value such that the molecular weight of the polyoxypropylene hydrophobic base is at least 900 and m has value such that the oxyethylene content of the molecule is from 10% to 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional useful conjugated polyoxyalkylene surface-active agents correspond to the formula: P[(C₃H₆O)ₙ(C₂H₄O)ₘH]ₓ wherein P is the residue of an organic compound having from 8 to 18 carbon atoms and containing x reactive hydrogen atoms in which x has a value of 1 or 2, n has a value such that the molecular weight of the polyoxyethylene portion is at least 44 and m has a value such that the oxypropylene content of the molecule is from 10% to 90% by weight. In either case the oxypropylene chains may contain optionally, but advantageously, small amounts of ethylene oxide and the oxyethylene chains may contain also optionally, but advantageously, small amounts of propylene oxide.

8. Polyhydroxy fatty acid amide surfactants include those having the structural formula R₂CONR₁Z in which: R₁ is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction, such as a glycityl moiety.

9. The alkyl ethoxylate condensation products of aliphatic alcohols with from 0 to 25 moles of ethylene oxide are suitable. The alkyl chain of the aliphatic alcohol can either be straight or branched, primary or secondary, and generally contains from 6 to 22 carbon atoms.

10. The ethoxylated C₆-C₁₈ fatty alcohols and C₆-C₁₈ mixed ethoxylated and propoxylated fatty alcohols are suitable surfactants, particularly those that are water soluble. Suitable ethoxylated fatty alcohols include the C₁₀-C₁₈ ethoxylated fatty alcohols with a degree of ethoxylation of from 3 to 50.

11. Further exemplary nonionic surfactants suitable for the compositions can include alkyl polyglucosides. Alkyl polyglucosides are a type of alkyl polyglycoside derived from a glucose-based polymer. An alkyl polyglucoside, as used herein in this disclosure, is a molecule having one to ten glucose units backbone and at least one alkyl group attached one of the OH groups and has a generic structure of

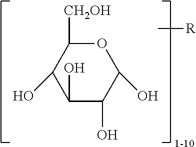

wherein R is an alkyl group and can be attached to any or all of the OH group in the molecule. A cationic alkyl polyglucoside, as used herein in this disclosure, is an alkyl polyglucoside having at least one cationic group in its alkyl group(s). Preferably, the alkyl group has a carbon chain length between about 1 and about 20 carbons, more preferably between about 2 and about 18 carbons, and most preferably between about 4 and about 16 carbons.

12. Fatty acid amide surfactants include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)ₓH, where x is in the range of from 1 to 3.

13. Nonionic surfactants also include the class defined as alkoxylated amines or, most particularly, alcohol alkoxylated/aminated/alkoxylated surfactants. These nonionic surfactants may be at least in part represented by the general formulae: R²⁰—(PO)ₛN-(EO)ₜH,

R²⁰—(PO)ₛN-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, and t is 1-10, preferably 2-5. Other variations on the scope of these compounds may be represented by the alternative formula: R²⁰—(PO)ᵥ—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5.

14. Reverse polyoxyalkylene block copolymer(s) (also known as alkoxylated block copolymer(s)). The reverse polyoxyalkylene block copolymers, especially -(EO)ₑ—(PO)ₚ block copolymers, are effective in preventing or minimizing any normal foaming activity of other components. Because of their better water-solubility characteristics, the reverse polyoxyethylene-polyoxypropylene (i.e., reverse -(EO)ₑ—(PO)ₚ) block copolymers are preferred over other reverse polyoxyalkylene block copolymers, such as those that contain polyoxybutylene blocks.

The polyoxyalkylene block copolymers useful in the present compositions can be formed by reacting alkylene oxides with initiators. Preferably, the initiator is multifunctional because of its use results in “multibranch” or “multiarm” block copolymers. For example, propylene glycol (bifunctional), triethanol amine (trifunctional), and ethylenediamine (tetrafunctional) can be used as initiators to initiate polymerization of ethylene oxide and propylene oxide to produce reverse block copolymers with two branches (i.e., arms or linear units of polyoxyalkylenes), three branches, and four branches, respectively. Such initiators may contain carbon, nitrogen, or other atoms to which arms or branches, such as blocks of polyoxyethylene (EO)ₑ, polyoxypropylene (PO)ₚ, polyoxybutylene (BO)_{b}, -(EO)ₑ—(PO)ₚ, -(EO)ₑ—(BO)_{b}, or -(EO)₃—(PO)ₚ—(BO)_{b}, can be attached. Preferably, the reverse block copolymer has arms or chains of polyoxyalkylenes that are attached to the residues of the initiators contain end blocks of -(EO)ₓ—(PO)_{y}, which have ends of polyoxypropylene (i.e., —(PO)_{y}), wherein x is about 1 to 1000 and y is about 1 to 500, more preferably x is about 5 to 20 and y is about 5 to 20.

The reverse block copolymer can be a straight chain, such as a three-block copolymer, (PO)_{y}-(EO)ₓ—(PO)_{y} wherein x is about 1 to 1000, preferably about 4 to 230; and y is about 1 to 500, preferably about 8 to 27. Such a copolymer can be prepared by using propylene glycol as an initiator and adding ethylene oxide and propylene oxide. The polyoxyalkylene blocks are added to both ends of the initiator to result in the block copolymer. In such a linear block copolymer, generally the central (EO)ₓ contains the residue of the initiator and x represents the total number of EO on both sides of the initiator. Generally, the residue of the initiator is not shown in a formula such as the three-block copolymer above because it is insignificant in size and in contribution to the property of the molecule compared to the polyoxyalkylene blocks. Likewise, although the end block of the polyoxyalkylene block copolymer terminates in a —OH group, the end block is represented by —(PO)ₚ, -(EO)ₓ, —(PO)_{y}, and the like, without specifically showing the —OH at the end. Also, x, y, and z are statistical values representing the average number of monomer units in the blocks.

The reverse polyoxyalkylene block copolymer can have more than three blocks, an example of which is a five-block copolymer, (PO)_{z}-(EO)_{y}—(PO)ₓ-(EO)_{y}—(PO)_{z} wherein x is about 1 to 1,000, preferably about 7 to 21; y is about 1 to 500, preferably about 10 to 20; and z is about 1 to 500, preferably about 5 to 20.

A chain of blocks may have an odd or even number of blocks. Also, in other embodiments, copolymers with more blocks, such as, six, seven, eight, and nine blocks, etc., may be used as long as the end polyoxyalkylene block is either (PO)ₚ or (BO)_{b}. As previously stated, the reverse -(EO)ₑ—(PO)ₚ block copolymer can also have a branched structure having a trifunctional moiety T, which can be the residue of an initiator. The block copolymer is represented by the formula:

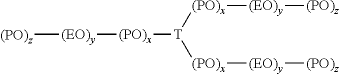

wherein x is about 0 to 500, preferably about 0 to 10; y is about 1 to 500, preferably about 5 to 12, and z is about 1 to 500, preferably about 5 to 10.

Preferred nonionic surfactants include, but are not limited to, reverse Pluronic surfactant having (PO)(EO)(PO) structure and an average molecular weight of less than 3000 g/mole, more preferably less than 2800 g/mole, still more preferably less than 2500 g/mole, wherein the cloud point of a 1% aqueous solution of the surfactant is greater than 30° C., more preferably greater than 35° C., still more preferably greater than 40° C., and most preferably greater than 45° C.

Examples of alcohol alkoxylates suitable for use in the rinse aid compositions can include those that are often classified as association disruption agents and include ethylene oxides, propylene oxides, butylene oxides, pentalene oxides, hexylene oxides, heptalene oxides, octalene oxides, nonalene oxides, decylene oxides, and mixtures and derivatives thereof. One example is RA 300 from BASF of the formula R—O-(EO)ₓ(PO)_{y}—H which is a capped alcohol alkoxylate. Extended surfactants, because of the central PO block also serve as an association disruption agent.

Examples of alcohol ethoxylates can have structure represented by Formula I: R—O—(CH₂CH₂O)ₙ—H (I) wherein R is a (C₁-C₁₂) alkyl group and n is an integer in the range of 1 to 100. In some embodiments, R may be a (C₈-C₁₂) alkyl group, or may be a (C₈-C₁₀) alkyl group. Similarly, in some embodiments, n is an integer in the range of 10-50, or in the range of 15-30, or in the range of 20-25. In some embodiments, the one or more alcohol ethoxylate compounds are straight chain hydrophobes. In some embodiments, there can be at least two different alcohol ethoxylate compounds each having structure represented by Formula I. That is, the R and/or n variables of Formula I, or both, may be different in the two or more different alcohol ethoxylate compounds present in the sheeting agent. For example, there may be a first alcohol ethoxylate compound in which R is a (C₈-C₁₀) alkyl group, and a second alcohol ethoxylate compound in which R is a (C₁₀-C₁₂) alkyl group. In at least some embodiments, the surfactant does not include any alcohol ethoxylate compounds that include an alkyl group that has more than 12 carbon atoms. In some embodiments, the surfactant includes only alcohol ethoxylate compounds that include an alkyl group that has 12 or fewer carbon atoms.

15. Branched Alcohol Alkoxylates

Branched alcohol alkoxylate nonionic surfactants are also suitable for the compositions disclosed herein. Preferred branched alcohol alkoxylates include, but are not limited to, Guerbet alcohol alkoxylates having alkoxylation of: POₐ-EO_{b} or POₐ-EO_{b}-PO_{c} wherein a is between about 1 and about 10; wherein b is between about 1 and about 14; and wherein c is between about 1 and about 20; and wherein the branched alkyl group has between about 6 and about 20 carbons, more preferably between about 6 and about 18, most preferably between about 8 and about 16.

16. Extended Chain Nonionic Surfactants

Extended chain nonionic surfactants have an intermediate polarity poly-alkylene oxide chain (or linker) inserted between the lipophilic tail group and hydrophilic polar head, which may be anionic or nonionic. Examples of lipophilic tail groups include hydrocarbons, alkyl ether, fluorocarbons or siloxanes. Examples of anionic hydrophilic polar heads of the extended surfactant include, but are not necessarily limited to, groups such as sulfate, polyoxyethylene sulfate, ethoxysulfate, carboxylate, ethoxy-carboxylate, phosphate, ethoxyphosphates. Examples of nonionic hydrophilic polar heads of the extended surfactant include, but are not necessarily limited to, groups such as polyoxyethylene, C6 sugar, xylitol, di-xylitol, ethoxy-xylitol, and glucose.

Extended surfactants include a linker polyalkylene glycol link. The general formula for a nonionic extended surfactant is R-[L]ₓ[O—CH₂—CH₂]_{y} where R is the lipophilic moiety, such as a linear or branched, saturated or unsaturated, substituted or unsubstituted, aliphatic or aromatic hydrocarbon radical having from about 8 to 20 carbon atoms, L is a linking group, such as a block of poly-alkylene oxide, preferably polypropylene oxide; x is the chain length of the linking group ranging from 2-25; and y is the average degree of ethoxylation ranging from 1-18. In a preferred embodiment, applicants have found that use of a nonionic surfactant with enough PO extension as the main surfactant (and only) can form liquid single phase microemulsions. PO length is optimized at from about 5 to about 8 moles of PO. This length of PO extension provides a lower foam profile. Applicants have further found that R groups that are a branched hydrophobe such as a guerbet alcohol are better for protein soil defoaming. Exemplary extended surfactants include: branched Guerbet alcohol alkoxylates; such as C₁₀(PO)₈(EO)ₓ (x=3, 6, 8, 10) also, extended linear alcohol alkoxylates; C₍₁₂₋₁₄₎(PO)₁₆(EO)ₓ (x=6, 12, 17). Additional disclosure of extended chain nonionic surfactants is set forth in U.S. Pat. No. 11,028,341, which is herein incorporated by reference in its entirety.

### Semi-Polar Nonionic Surfactants

The semi-polar type of nonionic surface active agents are another class of nonionic surfactant useful in compositions of the present invention. Generally, semi-polar nonionics are high foamers and foam stabilizers, which can limit their application in CIP systems. However, within compositional embodiments of this invention designed for high foam cleaning methodology, semi-polar nonionics would have immediate utility. The semi-polar nonionic surfactants include the amine oxides, phosphine oxides, sulfoxides and their alkoxylated derivatives.

17. Amine oxides are tertiary amine oxides corresponding to the general formula:

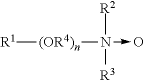

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, etradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Useful semi-polar nonionic surfactants also include the water soluble phosphine oxides having the following structure:

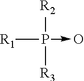

wherein the arrow is a conventional representation of a semi-polar bond; and, R¹ is an alkyl, alkenyl or hydroxyalkyl moiety ranging from 10 to about 24 carbon atoms in chain length; and, R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethylhexadecylphosphine oxide, diethyl-2-hydroxyoctyldecylphosphine oxide, bis(2-hydroxyethyl)dodecylphosphine oxide, and bis(hydroxymethyl)tetradecylphosphine oxide.

Semi-polar nonionic surfactants useful herein also include the water soluble sulfoxide compounds which have the structure:

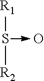

wherein the arrow is a conventional representation of a semi-polar bond; and, R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions of the invention include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

In preferred embodiments the nonionic surfactant is a polyoxyethylene-polyoxypropylene block copolymer, alcohol alkoxylates, low molecular weight EO containing surfactants, or combination thereof. Exemplary commercially-available extended surfactants are available under the tradenames Plurafac, including Plurafac SL-42, Plurafac SL-62, Lutensol XL (e.g. Lutensol XL40, Lutensol XL50, Lutensol XL60, Lutensol XL70, Lutensol XL79, etc.), Ecosurf (e.g. Ecosurf EH-3, Ecosurf EH-6, etc.), and Surfonic.

In embodiments the rinse aid compositions do not include ethoxylated glycerol esters.

In additional embodiments the rinse aid compositions can include other surfactants in addition to the nonionics described herein, including for example cationic, amphoteric and/or zwitterionic surfactants.

Solidification Agents and/or Carriers

The solid compositions contain at least one neutral solidification agent. In some embodiments a solidification agent can function as a carrier for liquid compositions. A neutral solidification agent refers to agents that are not alkalinity sourced that would substantially change or change the pH of the rinse aid composition, such as an alkali metal hydroxide and/or alkali metal carbonate. In an embodiment the compositions are free of or substantially-free of alkali metal hydroxide and/or alkali metal carbonate.

In some embodiments, one or more solidification agents may be included in the rinse aid composition. Examples of solidification agents include urea, an amide such stearic monoethanolamide or lauric diethanolamide or an alkylamide, and the like; sulfate salts or sulfated surfactants, and aromatic sulfonates, and the like including short-chain alkylbenzene sulfonates and/or alkyl naphthalene sulfonates; a solid polyethylene glycol, or a solid EO/PO block copolymer, and the like; neutral inorganic salts (e.g. magnesium sulfate), starches that have been made water-soluble through an acid or alkaline treatment process; various inorganics that impart solidifying properties to a heated composition upon cooling, and the like. Such compounds may also vary the solubility of the composition in an aqueous medium during use such that the rinse aid and/or other active ingredients may be dispensed from the solid composition over an extended period of time.

In embodiments where a solidification agent (or carrier in a liquid formulation) is included in the compositions, it is preferably included in an amount between about 1 wt-% to about 90 wt-%, between about 10 wt-% to about 90 wt-%, between about 10 wt-% to about 80 wt-%, between about 20 wt-% to about 70 wt-%, or between about 25 wt-% to about 70 wt-%. In addition, without being limited according to the disclosure, all ranges recited are inclusive of the numbers defining the range and include each integer within the defined range.

### Water

The compositions contain water. In an exemplary embodiment the liquid composition comprises water as a carrier, the water can be deionized water or softened water.

The water typically makes up the remaining volume after the addition of all other ingredients. However, in liquid compositions water can be included in amounts from about 10 wt-% to about 90 wt-%, from about 20 wt-% to about 90 wt-%, from about 20 wt-% to about 80 wt-%, from about 20 wt-% to about 70 wt-%, or from about 20 wt-% to about 60 wt-%. In addition, without being limited according to the disclosure, all ranges recited are inclusive of the numbers defining the range and include each integer within the defined range.

### Additional Functional Ingredients

The components of the detergent composition can further be combined with various functional components suitable for uses disclosed herein. In some embodiments, the rinse aid compositions including the enzyme, phosphonate and nonionic surfactants make up a large amount, or even substantially all of the total weight of the rinse aid compositions. For example, in some embodiments few or no additional functional ingredients are disposed therein.

In other embodiments, additional functional ingredients may be included in the detergent compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the rinse aid compositions may include optical brighteners, defoaming agents, anti-redeposition agents, bleaching agents, solubility modifiers, dispersants, metal protecting agents, stabilizing agents (e.g. additional enzyme stabilizers), corrosion inhibitors, builders/sequestrants/chelating agents, aesthetic enhancing agents including fragrances and/or dyes, additional rheology and/or solubility modifiers or thickeners, hydrotropes or couplers, buffers or pH modifiers, solvents, additional cleaning agents and the like.

According to embodiments of the disclosure, the various additional functional ingredients may be provided in a liquid or a solid composition in the amount from about 0 wt-% and about 70 wt-%, from about 0 wt-% and about 60 wt-%, from about 0 wt-% and about 50 wt-%, from about 0.1 wt-% and about 50 wt-%, from about 1 wt-% and about 50 wt-%, from about 1 wt-% and about 40 wt-%, from about 1 wt-% and about 30 wt-%, from about 1 wt-% and about 25 wt-%, or from about 1 wt-% and about 20 wt-%. In addition, without being limited according to the disclosure, all ranges recited are inclusive of the numbers defining the range and include each integer within the defined range.

These additional ingredients can be pre-formulated with the rinse aid compositions or added to the use solution before, after, or substantially simultaneously with the addition of the compositions.

According to preferred embodiments, the rinse aid compositions do not include a modified gum-based polysaccharide, a cationic guar or cationic guar derivative, including for example a hydroxypropyl-modified guar or hydroxypropyl-modified guar derivative such as guar gum 2 hydroxy-3-(trimethylammonium)propyl ether chloride (commercially available as JAGUAR® C 500 N from Solvay) and/or guar gum 2-hydroxypropyl ether (commercially available as MIRAPOL® Surf N and JAGUAR® HP 105 from Solvay).

### Buffers and pH Modifiers

The compositions can include a buffer and/or pH modifier to adjust the pH or act as a buffer to adjust pH for enzyme stability.

Suitable buffers can include, but are not limited to, glycine buffers, alcohol amines (e.g. 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like), ethanolamines, C1-C6 polycarboxylic acids, alkali metal carbonates, bicarbonates, sesquicarbonates, and mixtures thereof.

Suitable pH modifiers can include water soluble acids. Preferred acids can be organic and/or inorganic acids and their salts that are water soluble. Preferred inorganic acids include, but are not limited to, boric acid, hydrobromic acid, hydrochloric acid, hydrofluoric acid, hydroiodic acid, hypophosphorous acid, phosphoric acid, phosphorous acid, polyphosphoric acid, sulfamic acid, sulfuric acid, sulfurous acid, sodium bisulfate, sodium bisulfite, their salts and mixtures thereof. Preferred organic acids include, but are not limited to, acetic acid, acrylic acids, adipic acid, benzoic acid, butyric acid, caproic acid, citric acid, formic acid, fumaric acid, gluconic acid or its precursor glucono-δ-lactone, glutaric acid, hydroxy acetic acid, isophthalic acid, lactic acid, lauric acid, maleic acid, malic acid, malonic acid, palmitic acid, pimelic acid, polymaleic-acrylic acids, polyacrylic acids, propionic acid, sebacic acid, stearic acid, suberic acid, succinic acid, tartaric acid, terephthalic acid, uric acid, valeric acid, their salts and mixtures thereof. Preferred acid salts include, but are not limited to, acetic acid salts, citric acid salts, formic acid salts, and mixtures thereof.

### Polyols

The compositions can optionally comprise a polyol. Preferred polyols include, but are not limited to, C2-C10 polyols, more preferably C3-C8 polyols, most preferably C3-C6 polyols. Preferred polyols include, but are not limited to, erythritol, ethylene glycol, galactitol, glycerin, inositol, mannitol, propylene glycol, sorbitol, and mixtures thereof. Without being limited to a mechanism of action in the liquid compositions the polyols, including, but not limited to propylene glycol benefit the phase stability of the compositions. In some embodiments, it is preferable to include multiple polyols—one or more to provide enzyme stability and one or more to provide phase stability for the composition. Most preferred polyols for enzyme stability comprise propylene glycol, glycerin, sorbitol, and mixtures thereof.

In an exemplary embodiment of rinse aid composition including a polyol, it is included in an amount between about 0.01 wt-% and about 60 wt-%, between about 1 wt-% and about 50 wt-%, between about 5 wt-% and about 45 wt-%. In additional embodiments a polyol is included in the composition in an amount between about 10 wt-% and about 60 wt-%, between about 10 wt-% and about 50 wt-%, between about 15 wt-% and about 45 wt-%. In a further exemplary embodiment of rinse aid composition including a polyol, it is included in an amount between about 0.01 wt-% and about 30 wt-%, between about 0.1 wt-% and about 20 wt-%, or between about 0.5 wt-% and about 20 wt-%. In addition, without being limited according to the disclosure, all ranges recited are inclusive of the numbers defining the range and include each integer within the defined range.

### Thickening Agent

The compositions can optionally include a thickening agent. In some embodiments agents that may be considered thickening agents (e.g. glycerin and polymers) provide enzyme stabilization and/or water conditioning. Preferred thickening agents can be organic or inorganic. Preferred organic thickening agents include, but are not limited to, acrylic copolymers, carboxyvinyl polymers, corn starch, crosslinked polyacrylic acid-type thickening agents, fatty acid thixotropic thickeners, guar gum, guar hydroxy propyltrimonium chloride, polyacrylate polymers, poly(methylvinylether/maleic) anhydride polymers, and mixtures thereof.

As used herein, “polyacrylic acid-type” is intended to refer to water soluble homopolymers of acrylic acid or methacrylic acid or water-dispersible or water-soluble salts, esters and amides thereof, or water-soluble copolymers of these acids or their salts, esters or amides with each other or with one or more ethylenically unsaturated monomers, such as styrene, maleic acid, maleic anhydride, 2-hydroxyethylacrylate, acrylonitrile, vinyl acetate, ethylene, propylene, or the like. Preferably, the polyacrylic thickening agent is one of the crosslinked polyacrylic acid-type thickening agents commercially available as CARBOPOL™. The CARBOPOL™ resins, also known as carbomer resins, are hydrophilic, high molecular weight, crosslinked acrylic acid polymers. The CARBOPOL™ resins are crosslinked with a polyalkenyl polyether, such as a polyalkyl ether of sucrose having an average of 5.8 alkyl groups per molecule of sucrose. Other suitable carbomer thickening agents include the PNC carbomers.

Suitable fatty acid thixotropic thickeners, include, but are not limited to, higher aliphatic fatty monocarboxylic acids having from about 8 to about 22 carbon atoms, inclusive of the carbon atom of the carboxyl group of the fatty acid. The aliphatic radicals are saturated and can be straight or branched. Mixtures of fatty acids may be used, such as those derived from natural sources, such as tallow fatty acid, coco fatty acid, soya fatty acid, etc., or from synthetic sources available from industrial manufacturing processes.

Examples of the fatty acids which can be used as thickeners include, for example, decanoic acid, lauric acid, dodecanoic acid, palmitic acid, myristic acid, stearic acid, oleic acid, eicosanoic acid, tallow fatty acid, coco fatty acid, soya fatty acid and mixtures of these acids. The metal salts of the above fatty acids can also be used in as thixotropic thickener agents, such as salts of the monovalent and polyvalent metals such as sodium, potassium, magnesium, calcium, aluminum and zinc. Suitable metal salts, include, but are not limited to, aluminum salts in triacid form, e.g., aluminum tristearate, Al(OCOC₁₇H₃₅)₃, monoacid salts, e.g., aluminum monostearate, Al(OH)₂(OCOC₁₇H₃₅) and diacid salts, e.g. aluminum distearate, Al(OH)(OCOC₁₇H₃₅)₂, and mixtures of two or three of the mono-, di- and triacid salts can be used for those metals, e.g., Al, with valences of +3, and mixtures of the mono- and diacid salts can be used for those metals, e.g., Zn, with valences of +2. The thickening agent used can also be any one of a number of natural or synthetic inorganic materials, such as clays, silicas, aluminas, titanium dioxide (pyrogenic) and calcium and/or magnesium oxides. All of these materials are readily available from commercial sources.

### Preservatives

The rinse aid compositions can optionally include a preservative. Suitable preservatives include, but are not limited to, the antimicrobial classes such as phenolics, quaternary ammonium compounds, metal derivatives, amines, alkanol amines, nitro derivatives, analides, organosulfur and sulfur-nitrogen compounds and miscellaneous compounds. Exemplary phenolic agents include pentachlorophenol, orthophenylphenol. Exemplary quaternary antimicrobial agents include benzalconium chloride, cetylpyridiniumchloride, amine and nitro containing antimicrobial compositions such as hexahydro-1,3,5-tris(2-hydroxyethyl)-s-triazine, dithiocarbamates such as sodium dimethyldithiocarbamate, and a variety of other materials known in the art for their microbial properties. Other exemplary preservatives include gluteraldehyde, Bronopol, silver, and isothiazolones such as methylisothiazolinone. Preferred preservatives include those sold under the tradename NEOLONE™.

Further suitable preservatives include a GRAS preservative system for acidification of the solid rinse aid including sodium bisulfate and organic acids. In at least some embodiments, an effective amount of sodium bisulfate and one or more other acids are included as a preservative, system. Suitable acids include for example, inorganic acids, such as HCl and or acids. In certain further embodiments, an effective. amount of sodium bisulfate and one or more organic acids are included in the solid rinse aid composition. as a preservative system. Suitable organic acids include sorbic, acid, benzoic acid, ascorbic acid, erythorbic acid, citric acid, etc. Preferred organic acids include benzoic and ascorbic acid.

Preferred preservatives for use in the rinse aid compositions include, methylchloroisothiazolinone, methylisothiazolinone, or a blend of the same. A blend of methylchloroisothiazolinone and methylisothiazolinone is available from Dow Chemical under the trade name KATHON™ CG. Additional preferred preservatives include salts of pyrithione, including, for example sodium pyrithione.

If a preservative is included in the compositions, it is preferably in an amount between about 0.01 wt-% and about 10 wt-%. In addition, without being limited according to the disclosure, all ranges recited are inclusive of the numbers defining the range and include each integer within the defined range.

### Systems

A detergent and rinse aid system is also disclosed and can comprise, consist of or consist essentially of: a first part comprising an alkaline ware wash detergent composition; and a second part comprising the rinse aid composition as described herein.

In additional embodiments, a detergent and rinse aid system can comprise, consist of or consist essentially of: (a) a first part comprising an alkaline ware wash detergent composition, and a second part comprising the rinse aid composition as described herein; or (b) a first part comprising 2-in-1 ware wash detergent and rinse aid composition, and a second part comprising a protease enzyme booster; or (c) a first part comprising an alkaline ware wash detergent, a second part comprising a rinse aid composition that is free of enzyme, and a third part comprising a protease enzyme booster.

The various embodiments of the systems described herein use either the rinse aid compositions as described herein or a booster comprising the protease enzyme to enhance the overall performance of ware washing, i.e. additional soil removal is achieved in the rinse cycle. In embodiments, the systems can reduce the demand on the detergent in the system which in some embodiments can reduce the required concentration or consumption of the detergent composition (or a 2-in-1 detergent and rinse aid composition).

### Methods of Use

Methods of cleaning and rinsing ware include contacting the rinse aid composition to ware in a ware washing process during a rinsing step. The method includes a first step of contacting the ware with an alkaline detergent composition or a 2-in-1 detergent and rinse aid composition and thereafter contacting the ware with the rinse aid composition according to the embodiments described herein. The rinse aid composition can be a solid or liquid, and a concentrate or a use composition. In embodiments where a solid or a concentrate composition is provided, a step of diluting the composition takes place, such as through dispensing equipment whereby water is sprayed at the solid composition or water is added in the ware washing rinse step with the rinse aid composition to form a use solution. In embodiments, the water flow is delivered at a relatively constant rate using mechanical, electrical, or hydraulic controls and the like. The solid concentrate composition can also be diluted through dispensing equipment whereby water flows around the solid block, creating a use solution as the solid concentrate dissolves. The solid concentrate composition can also be diluted through pellet, tablet, powder and paste dispensers, and the like.

Beneficially in embodiments the use of the rinse aid composition comprising the enzyme enhances the overall performance of the ware washing, i.e. additional soil removal is achieved in the rinse cycle. In embodiments, the methods can reduce the demand on the detergent in the washing cycle which can include reducing the required concentration or consumption of the detergent composition (or a 2-in-1 detergent and rinse aid composition). Such benefit is most prevalent in extreme conditions, such as low temperature ware washing, heavily soiled ware, etc. The ability to reduce the demand on the detergent and/or consumption of the detergent composition provides sustainability benefits.

Conventional dispensing equipment can be employed. For example, commercially available dispensing equipment which can be used and is available from Ecolab, Inc. Use of such dispensing equipment results in the dispensing of the initial detergent composition or a 2-in-1 detergent and rinse aid composition, and thereafter the rinse aid composition by a water source to form the aqueous use solution. The water used to dilute the concentrate (water of dilution) can be available at the locale or site of dilution. The water of dilution may contain varying levels of hardness depending upon the locale. Service water available from various municipalities have varying levels of hardness. It is desirable to provide a concentrate that can handle the hardness levels found in the service water of various municipalities. The water of dilution that is used to dilute the concentrate can be characterized as hard water when it includes at least 1 grain hardness. It is expected that the water of dilution can include at least 5 grains hardness, at least 10 grains hardness, or at least 20 grains hardness. During the rinsing step, generally warm or hot water flows over the surfaces to be washed and rinsed.

Alternatively, an enzyme or enzyme composition may be provided as a separate input or stream from the detergent composition, 2-in-1 composition, or rinse aid composition, such as added directly to the wash liquor or wash water of a particular application of use, e.g. dishwasher, preferably as an additional booster step.

In embodiments the rinse aid composition, booster or system is in contact with the ware in need of rinsing for a period of time of at least about 1 second, 2 seconds, 3 seconds, 4 seconds, 5 seconds, 6 seconds, 7 seconds, 8 seconds, 9 seconds, 10 seconds, 11 seconds, 12 seconds, 13 seconds 14 seconds, 15 seconds, 20 seconds, 25 seconds, 30 seconds, 35 seconds, 40 seconds, 45 seconds, 50 seconds, 55 seconds, 1 minute, 90 seconds, 2 minutes, 3 minutes, 4 minutes, 5 minutes, 6 minutes, 7 minutes, 8 minutes, 9 minutes, 10 minutes, or greater. In some embodiments the rinse aid composition, booster or system is in contact with the water for about 1 second to about 90 seconds, or from about 10 seconds to about 90 seconds.

The ware is further can be rinsed after allowing the rinse aid composition, booster, or system to contact the ware for sufficient time. In an exemplary embodiment, the ware is rinsed after contact with the composition. In another preferred embodiment, the ware is rinsed with water within a ware washing machine. The water can have a temperature between 70° C. and about 190° C., or preferably between about 70° C. and about 100° C., or for low temperature conditions a temperature between 50° C. and about 85° C.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The materials used in the following Examples are provided herein:

Acusol® 445 NG: Sodium Salt Acrylic polymer available from Dow Chemical.

Acusol® 445 ND: Sodium Salt Acrylic polymer available from Dow Chemical.

Alcalase 2.5 L, protease enzyme from Novozymes.

Amplify Prime, amylase enzyme from Novozymes.

ATMP: Aminotri(methylenephosphonate), sodium salt available from various sources.

Belclene 200, a calcium carbonate inhibitor.

Esperase 8 L, protease enzyme (B. subilisin) from Novozymes.

Esperase 6T, protease enzyme (B. subilisin) from Novozymes.

Flavourzyme 1000 L, protease enzyme from Novozymes.

Formea CTL 300BG, protease enzyme from Novozymes.

Kathon CG, mixed methylchloroisothiazolinone and methylisothiazolinone preservative.

Lipex Evity 200L, lipase enzyme from Novozymes.

Lutensol TDA 6: C11-C14 iso, C13-rich ethoxylated.

Lutensol XL40: a C10 guerbet alcohol alkoxylate from BASF.

Neolone M10, methyl isothiazolinone based preservative.

Plurafac® SLF 180: Branched alcohol alkoxylate, 2-propylheptanol available from BASF.

Plurafac® RA 300: C10-C16 alcohol alkoxylate available from BASF.

Progress Uno, a protease enzyme from Novozymes.

Surfonic® L24-12: C12-16 alcohol ethoxylate.

Tomadol 91-6: a nonionic alcohol ethoxylate surfactant.

D097: nonionic surfactant available from BASF

LDO97: Pluronic® F127 nonionic surfactant available from BASF.

Commercially available from multiple sources: HEDP (1-hydroxyethylidene-1,1-diphosphonic acid), PBTC (2-phosphonobutane-1,2,4 tricarboxylic acid), Dye, Potassium Hydroxide, Preservatives, Propylene glycol, Sodium Bicarbonate, Sodium Xylene Sulfonate (SXS an anionic surfactant), Urea prilled, Glycine, Glycerin, and Water.

### Example 1

Enzyme Stability

The enzyme stability of various rinse aid compositions were evaluated following a QATM 476 protease assay to determine activity of a proteolytic enzyme in a substrate. The activity of the protease enzymes was calculated based on the following:

$$Activity , KNPU / mL = \frac{\begin{matrix}( Activity Diluted Stock Std , KNPU / mL ) \\ ( Aliquot Diluted Stock , mL )\end{matrix}}{( Flask Volume , mL )}$$

The compositions were evaluated as solids and as a 10% solution. The compositions were further evaluated at room temperature (RT), 40° C., and 50° C. for 2, 4, 6, and 8 weeks. The results of stability are shown below each Table showing the evaluated rinse aid compositions for the solid and 10% solution stability (where NT indicates “not tested”). For purposes of this evaluation at least an 80% enzyme activity measurement was set as a testing threshold to identify clear differences between formulations. However, this was an experimental design only and does not represent a performance requirement as the enzyme stability at a lower threshold, e.g. 50% or greater, can provide beneficial results based on performance requirements for specific applications of use.

TABLE 3

| Name | SB-1 | SB-2 | SB-3 | SB-4 |
|---|---|---|---|---|
| Surfactants | 60-80 | 60-80 | 50-70 | |
| HEDP | 2.62 | 2.62 | 2.62 | |
| KOH | 1.4 | 1.4 | 1.4 | |
| Esperase 6T | 2 | | 2 | 4 |
| Esperase 8L | | 2 | | |
| Sodium | | | 12 | |
| Bicarbonate | | | | |
| Original granulate | | | | 96 |
| (See Table 4) | | | | |
| Additional | To 100 | To 100 | To 100 | To 100 |
| components | | | | |
| SUM | 100 | 100 | 100 | 100 |

TABLE 4
Granulates

| Name | Original | HEDP | ATMP | PBTC | Non Phos |
|---|---|---|---|---|---|
| Solid Carrier | 65-75 | 65-75 | 65-75 | 65-75 | 65-75 |
| Acusol 445NG | 5.1 | 5.1 | 5.1 | 5.1 | 5.1 |
| Surfactants | 15-30 | 15-30 | 15-30 | 15-30 | 15-30 |
| HEDP | | 1.73 | | | |
| ATMP | | | 1.68 | | |
| PBTC | | | | 4.53 | |
| Preservative/ | re- | re- | re- | re- | re- |
| Dye | mainder | mainder | mainder | mainder | mainder |
| % Surfactant | 21.6% | 21.6% | 21.6% | 21.6% | 21.6% |
| Activity | | | | | |

TABLE 5
Solid Stability of Rinse Aid Formulas

| Temp., Time | SB1 | SB2 | SB3 | SB4 |
|---|---|---|---|---|
| RT, 2 wk | NT | NT | 3% | 85% |
| RT, 4 wk | NT | NT | 14% | 80% |
| RT, 6 wk | NT | NT | 3% | NT |
| RT, 8 wk | NT | NT | 2% | 100% |
| 50 C., 2 wk | 100% | 0% | 3% | 92% |
| 50 C., 4 wk | 100% | 0% | 3% | 86% |
| 50 C., 6 wk | 38% | 0% | 3% | NT |
| 50 C., 8 wk | 0% | 0% | 3% | 100% |

TABLE 6
10% Solution Stability of Rinse Aid Formulas

| Temp., Time | SB2 | SB3 | SB4 |
|---|---|---|---|
| RT, 2 wk | 0% | 82% | 100% |
| RT, 4 wk | 0% | 100% | 100% |
| RT, 6 wk | 0% | 100% | |
| RT, 8 wk | 0% | 100% | 94% |
| 40 C., 2 wk | 0% | 53% | 85% |
| 40 C., 4 wk | 0% | 47% | 62% |
| 40 C., 6 wk | 0% | 30% | |
| 40 C., 8 wk | 0% | 17% | 51% |

The analyzed stability of the rinse aid compositions containing the protease enzymes shows that the rinse aid composition with enzymes can have liquid and solid stability with pH control. The results show that pH/buffered 10% concentrate performed well (SB3) while SB1 and SB2 did not have the same concentrate stability as the pH impacts the enzyme.

The rinse aid formulations of Table 7 (including the various stabilizer granulates of Table 4) were evaluated for liquid stability.

TABLE 7

| Name | SB10 | SB11 | SB12 | SB13 |
|---|---|---|---|---|
| Esperase 8L | 4 | 4 | 4 | 4 |
| HEDP gran | 96 | | | |
| ATMP gran | | 96 | | |
| PBTC gran | | | 96 | |
| Non Phos. gran | | | | 96 |

TABLE 8
10% Solution Stability of Rinse Aid Formulas

| Temp., Time | SB10 | SB11 | SB12 |
|---|---|---|---|
| RT, 2 wk | 61% | 85% | 57% |
| RT, 4 wk | 47% | 69% | 49% |
| RT, 6 wk | 35% | 70% | 38% |
| RT, 8 wk | 0% | 44% | 0% |
| 40 C., 2 wk | 24% | 38% | 24% |
| 40 C., 4 wk | 3% | 22% | 9% |
| 40 C., 6 wk | 0% | 13% | 2% |
| 40 C., 8 wk | 6% | 0% | 0% |

The results in Table 8 show the ATMP-based rinse aid formulation of SB11 has improved enzyme compatibility. The SB13 was not evaluated in this example as it does not have phosphonate in the formulation, and the comparison was between phosphonate-containing formulations for water conditioning.

TABLE 9

| Name | S5-1 | S5-2 | S5-3 | S5-4 | S5-5 | S5-6 |
|---|---|---|---|---|---|---|
| water | 36 | 36 | 66 | 36 | 36 | 66 |
| TEA | 7.1 | 7.1 | 7.1 | 7.1 | 7.1 | 7.1 |
| Citric, 50% | 0.9 | 0.9 | 0.9 | 0.9 | 0.9 | 0.9 |
| glycerin | 30 | | | 30 | | |
| propylene | | 30 | | | 30 | |
| glycol | | | | | | |
| Plurafac | 2 | 2 | 2 | 2 | 2 | 2 |
| SLF 180 | | | | | | |
| Lutensol XL40 | 2 | 2 | 2 | 2 | 2 | 2 |
| Tomadol 91-6 | 2 | 2 | 2 | 2 | 2 | 2 |
| Acusol 445N | 3 | 3 | 3 | 3 | 3 | 3 |
| SXS, 40% | 15 | 15 | 15 | 15 | 15 | 15 |
| Progress Uno | 2 | 2 | 2 | | | |
| Esperase | | | | 2 | 2 | 2 |
| | 100.00 | 100.00 | 100.00 | 100.00 | 100.00 | 100.00 |

TABLE 10
10% Solution Stability of Rinse Aid Formulas

| Temp., Time | S5-1 | S5-2 | S5-3 | S5-4 | S5-5 | S5-6 |
|---|---|---|---|---|---|---|
| RT, 2 wk | 95% | 92% | 94% | 100% | 100% | 100% |
| RT, 4 wk | 96% | 92% | 93% | 100% | 100% | 100% |
| RT, 6 wk | 85% | 84% | 85% | 100% | 100% | 99% |
| RT, 8 wk | 87% | 88% | 93% | 100% | 100% | 100% |
| 40 C., 2 wk | 100% | 95% | 99% | 100% | 100% | 58% |
| 40 C., 4 wk | 100% | 94% | 94% | 100% | 98% | 40% |
| 40 C., 6 wk | 89% | 80% | 82% | 89% | 85% | 28% |
| 40 C., 8 wk | 94% | 87% | 87% | 84% | 77% | 22% |
| 50 C., 2 wk | 98% | 85% | 86% | 83% | 6% | 10% |
| 50 C., 4 wk | 97% | 80% | 77% | 66% | 0% | 1% |
| 50 C., 6 wk | 80% | 68% | 60% | 47% | 0% | 0% |
| 50 C., 8 wk | 81% | 72% | 55% | 37% | 0% | 0% |

Enzymes are generally most stable at neutral conditions (6<pH<10). The analyzed stability of the rinse aid compositions containing the protease enzymes shows that traditional rinse aids having an acidic pH benefit from ‘neutralizing’ the pH. The stability results show benefits to varying solvents in the compositions (glycerin and propylene glycol) and that Progress Uno outperforms Esperase with stability up to 8 weeks at 50° C. with varying solvents.

### Example 2

Fifty Cycle Automatic Dish Wash Detergent Testing

The cleaning efficacy of the rinse aid compositions of Table 4 were evaluated using a 50 cycle redeposition experiment for ware wash detergents. The compositions were compared to a two-product system—a commercially-available control (solid detergent and rinse aid composition). To test the ability of compositions to clean glass, 6-10 oz. Libby heat resistant glass tumblers were used. The glass tumblers were cleaned prior to use.

A food soil solution was prepared using a 50/50 combination of beef stew and hot point soil and employed at 4000 ppm soil. The soil included two cans of Dinty Moore Beef Stew (1360 grams), one large can of tomato sauce (822 grams), 15.5 sticks of Blue Bonnet Margarine (1746 grams) and powered milk (436.4 grams). The hot point soil was added to the machine to maintain a sump concentration of about 4000 ppm.

After filling the dish machine with 1000 ppm of detergent and 17 grain water, the heaters were turned on. Testing was conducted in a Hobart AM15 ware wash machine. The wash temperature was adjusted to about 150-160° F. The final rinse temperature was adjusted to about 180° F. The controller was set to disclose the amount of detergent in the wash tank. The glass tumblers were placed in the dish machine. The dish machine was then started and run through an automatic cycle. At the beginning of each cycle the appropriate amount of hot point soil was added to maintain the sump concentration of 4000 ppm. The detergent concentration is controlled by conductivity. The rinse aid was dosed at 2.5 ml (10% solution). When the 50 cycles ended, the glasses were allowed to dry overnight. Thereafter they were graded for spots and film accumulation (visual).

The glass tumblers were then graded for protein accumulation using Coomassie Brilliant Blue R stain followed by destaining with an aqueous acetic acid/methanol solution. The Coomassie Brilliant Blue R stain was prepared by combining 1.25 g of Coomassie Brilliant Blue R dye with 45 mL of acetic acid and 455 mL of 50% methanol in distilled water. The destaining solution consisted of 45% methanol and 10% acetic acid in distilled water.

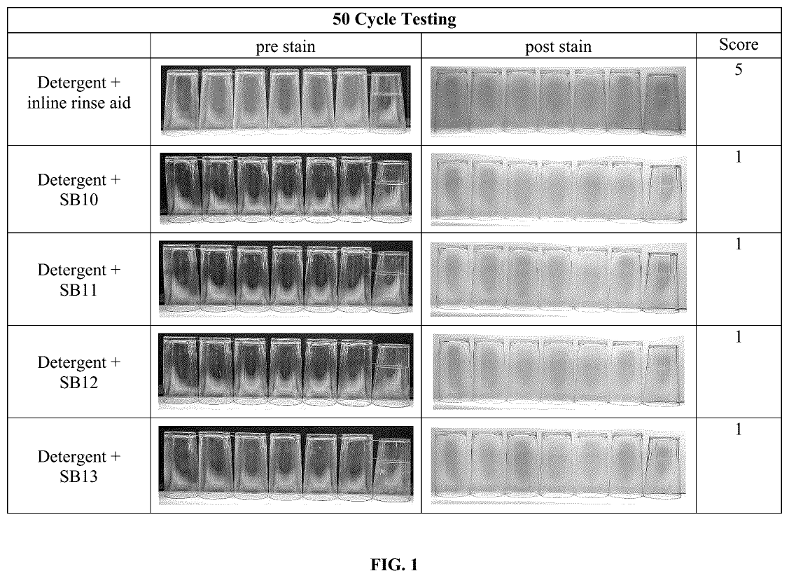

The results are shown in FIG. 1, which shows the exemplary rinse aid compositions of Table 4 pre-stain and post-stain, where all evaluated formulations showed a benefit of a Visual Ranking score of 1 compared to a 5 for the control confirming a benefit to additional soil removal with the inclusion of the enzyme in the rinse aid formulation. Scores were based on visual assessment. 1=little to now protein stain, 5=distinct heavy protein stain

### Example 3

Ten Cycle Automatic Dish Wash Detergent Testing

The cleaning efficacy of the rinse aid compositions of Table 4 were evaluated using a 10 cycle redeposition experiment for ware wash detergents. The compositions were compared to a two-product system—a commercially-available control (solid detergent including, and not including, a rinse aid composition). To test the ability of compositions to clean, 12 coated ceramic tiles were used. The ceramic tiles were cleaned prior to use.

A food soil solution was prepared using a 50/50 combination of beef stew and hot point soil and employed at 2000 ppm soil. The soil included two cans of Dinty Moore Beef Stew (1360 grams), one large can of tomato sauce (822 grams), 15.5 sticks of Blue Bonnet Margarine (1746 grams) and powered milk (436.4 grams). The hot point soil was added to the machine to maintain a sump concentration of about 2000 ppm. In addition, the ceramic tiles were painted with a 1:1 mixture of whole milk and cream of chicken soup.

After filling the dish machine with 1000 ppm of detergent and 17 grain water, the heaters were turned on. Testing was conducted in a Hobart AM15 ware wash machine. The wash temperature was adjusted to about 150-160° F. The final rinse temperature was adjusted to about 180-195° F. The controller was set to disclose the amount of detergent in the wash tank. The glass tumblers were placed in the dish machine. The dish machine was then started and run through an automatic cycle. At the beginning of each cycle the appropriate amount of hot point soil was added to maintain the sump concentration of 2000 ppm. The detergent concentration is controlled by conductivity. The rinse aid composition was dosed at 2.5 ml (10% solution). When the 10 cycles ended, the glasses were allowed to dry overnight. Thereafter they were graded for spots and film accumulation (visual).

The glass tumblers were then graded for protein accumulation using Coomassie Brilliant Blue R stain followed by destaining with an aqueous acetic acid/methanol solution. The Coomassie Brilliant Blue R stain was prepared by combining 1.25 g of Coomassie Brilliant Blue R dye with 45 mL of acetic acid and 455 mL of 50% methanol in distilled water. The destaining solution consisted of 45% methanol and 10% acetic acid in distilled water.

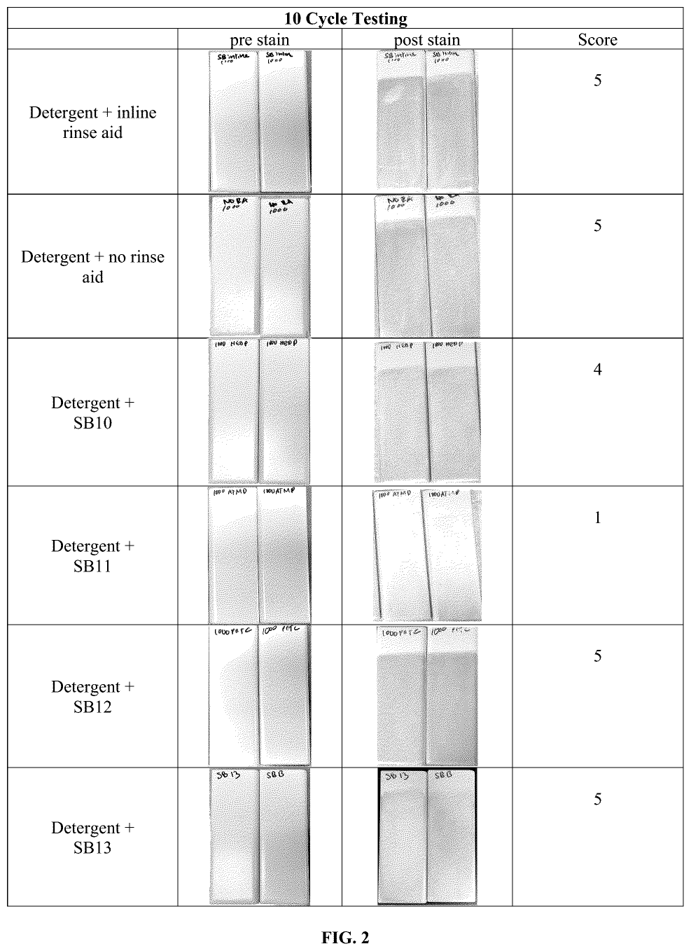

The results are shown in FIG. 2, which shows the scoring of the rinse aid compositions of Table 4 pre-stain and post-stain. These results show a significant improvement in performance of the rinse aid composition with ATMP and an enzyme (SB11) compared to the other formulations with various alternate phosphonates.

### Example 4

Fifty Cycle Automatic Dish Wash Detergent Testing

The cleaning efficacy of rinse aid compositions were evaluated using a 50 cycle redeposition experiment for ware wash detergents and evaluated to assess improvement in soil removal when used in combination with detergent compositions. The compositions were compared to a two-product system—a commercially-available control (solid detergent and rinse aid composition). To test the ability of compositions to clean glass, 6-10 oz. Libby heat resistant glass tumblers were used. The glass tumblers were cleaned prior to use.

A food soil solution was prepared using a 50/50 combination of beef stew and hot point soil and employed at 4000 ppm soil. The soil included two cans of Dinty Moore Beef Stew (1360 grams), one large can of tomato sauce (822 grams), 15.5 sticks of Blue Bonnet Margarine (1746 grams) and powered milk (436.4 grams). The hot point soil was added to the machine to maintain a sump concentration of about 4000 ppm.

After filling the dish machine with 1000 ppm of detergent, 2.5-3 mL of rinse aid, and 17 grain water, the heaters were turned on. The wash temperature was adjusted to about 150-160° F. The final rinse temperature was adjusted to about 180° F. The controller was set to disclose the amount of detergent in the wash tank. The glass tumblers were placed in the dish machine. The dish machine was then started and run through an automatic cycle. At the beginning of each cycle the appropriate amount of hot point soil was added to maintain the sump concentration of 4000 ppm. The detergent concentration is controlled by conductivity. When the 50 cycles ended, the glasses were allowed to dry overnight. Thereafter they were graded for spots and film accumulation (visual).

The glass tumblers were then graded for protein accumulation using Coomassie Brilliant Blue R stain followed by destaining with an aqueous acetic acid/methanol solution. The Coomassie Brilliant Blue R stain was prepared by combining 1.25 g of Coomassie Brilliant Blue R dye with 45 mL of acetic acid and 455 mL of 50% methanol in distilled water. The destaining solution consisted of 45% methanol and 10% acetic acid in distilled water.

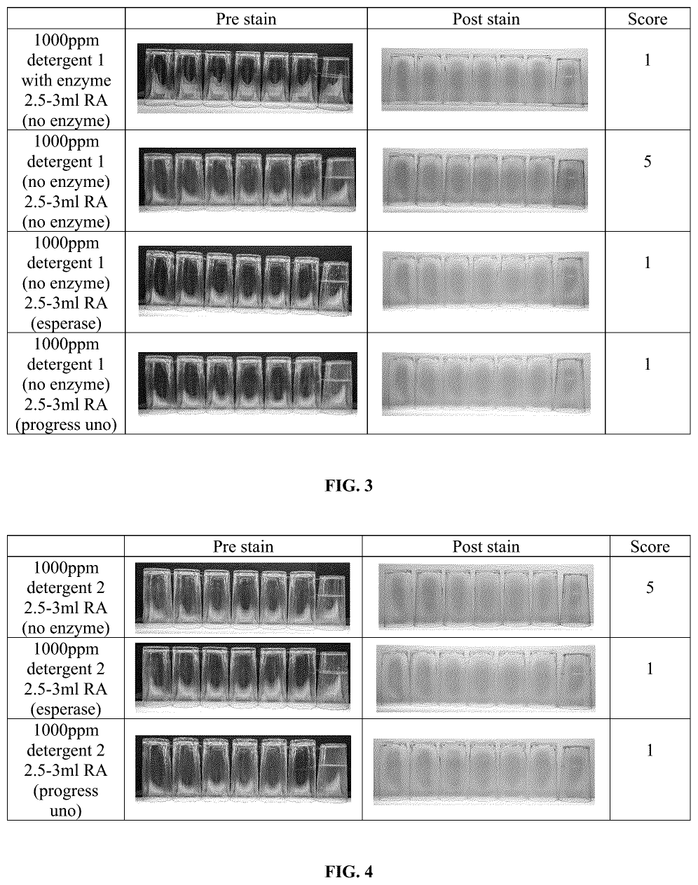

The results are shown in FIGS. 3-6, which shows the exemplary compositions pre-stain and post-stain. FIG. 3 shows glass tumblers washed with 1000 ppm of Commercial Detergent 1 (with and without enzymes) along with 2.5-3 mL of rinse aid (RA) with no enzyme, esperase, and progress uno. The results show that inclusion of the protease enzyme in the rinse aid compositions provides improvement in soil removal performance. FIG. 4 shows glass tumblers washed with 1000 ppm of Commercial Detergent 2 along with 2.5-3 mL of rinse aid (RA) with no enzyme, esperase, and progress uno. The results show again that inclusion of the protease enzyme in the rinse aid compositions provides improvement in soil removal performance of another commercial detergent composition.

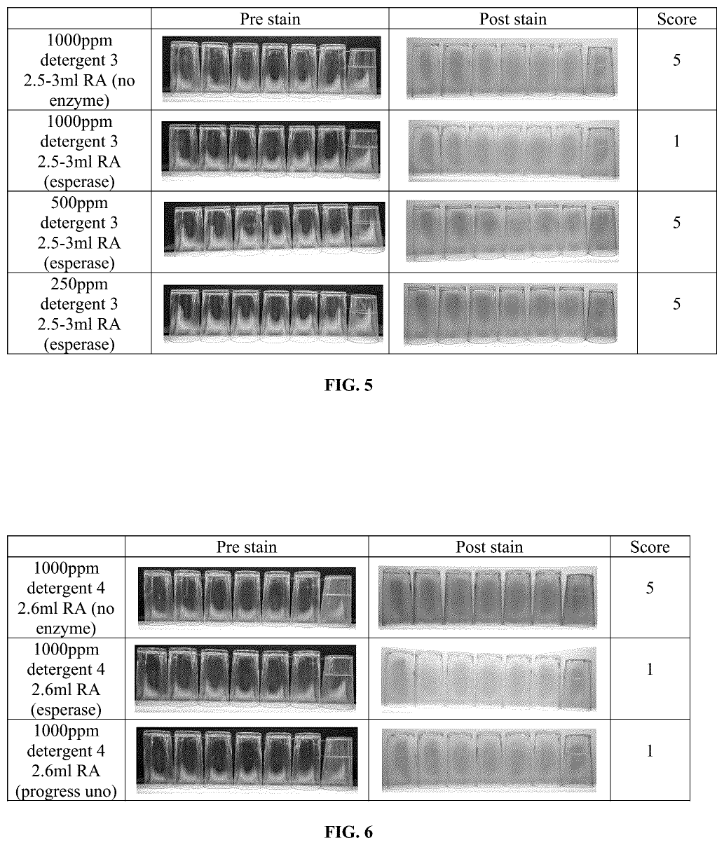

FIG. 5 shows glass tumblers washed with 1000 ppm, 500 ppm, and 250 ppm of Commercial Detergent 3 along with 2.5-3 mL of rinse aid (RA) with no enzyme and esperase. The testing evaluates potential to decrease detergent concentration based on improved performance when used with the rinse aid compositions as disclosed herein. Although the examples using 500 ppm detergent did not outperform the control, additional experiments with increased enzyme in the rinse aid composition are expected to improve performance and would provide a benefit in challenging soil removal conditions.

FIG. 6 shows glass tumblers washed with 1000 ppm of Commercial Detergent 4 along with 2.6 mL of rinse aid (RA) with no enzyme, esperase, and progress uno. The results show again that inclusion of the protease enzyme in the rinse aid compositions provides improvement in soil removal performance of another commercial detergent composition.

### Example 5

The cleaning efficacy of the rinse aid compositions of Table 11 were evaluated using a 10 cycle redeposition experiment for ware wash detergents, as described in Example 3.

TABLE 11

| Name | S6-1 | S6-2 | S6-3 | S6-4 | S6-5 | S6-6 | SRA14 |
|---|---|---|---|---|---|---|---|
| Water | 36 | 37.35 | 37.35 | 37.35 | 37.35 | 39.1 | |
| TEA | 7.1 | | | | | | |
| Citric Acid, 50% | 0.9 | | | | | | |
| Glycine | | 5 | 5 | 5 | 5 | 5 | |
| Glycerin | 13.32 | 13.32 | 13.32 | 13.32 | 13.32 | 13.32 | |
| Plurafac SLF 180 | 2 | 2 | 2 | 2 | 2 | 2 | |
| Lutensol XL40 | 2 | 2 | 2 | 2 | 2 | 2 | |
| Tomadol 91-6 | 2 | 2 | 2 | 2 | 2 | 2 | |
| Acusol 445N | 3 | 3 | 3 | 3 | 3 | 3 | |
| SXS, 40% | 30 | 30 | 30 | 30 | 30 | 30 | |
| ATMP | 1.68 | 1.68 | 1.68 | 1.68 | 1.68 | 1.68 | |
| NaOH, 50% | | 1.65 | 1.65 | 1.65 | 1.65 | 1.65 | |
| ATMP granulate | | | | | | | 96 |
| Esperase | 2 | | | | 2 | | |
| Alcalase 2.5L | | 2 | | | | | |
| Flavourzyme | | | 2 | | | | |
| 1000L | | | | | | | |
| Formea CTL | | | | 2 | | 0.25 | 4 |
| 300BG | | | | | | | |
| Total | 100 | 100 | 100 | 100 | 100 | 100 | 100 |

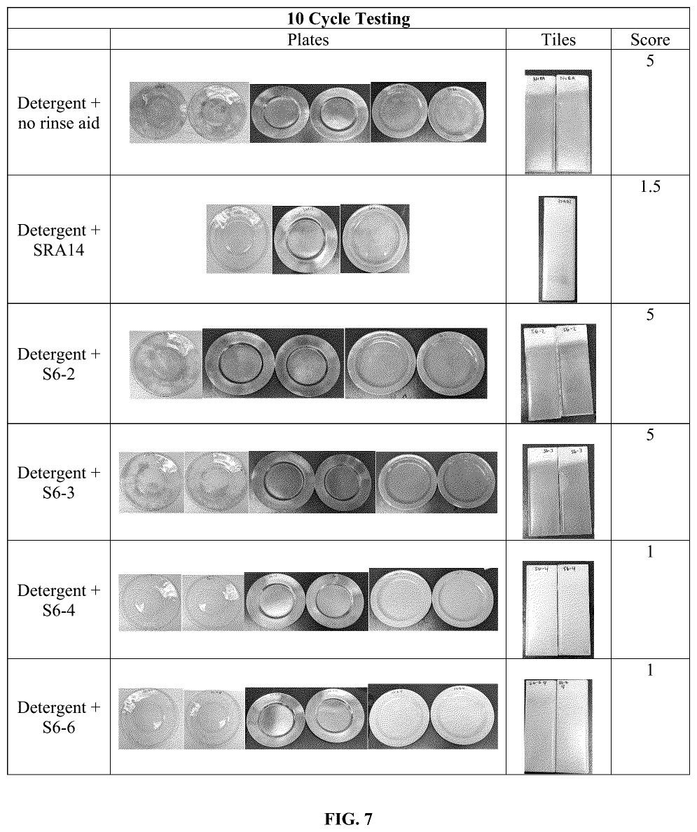

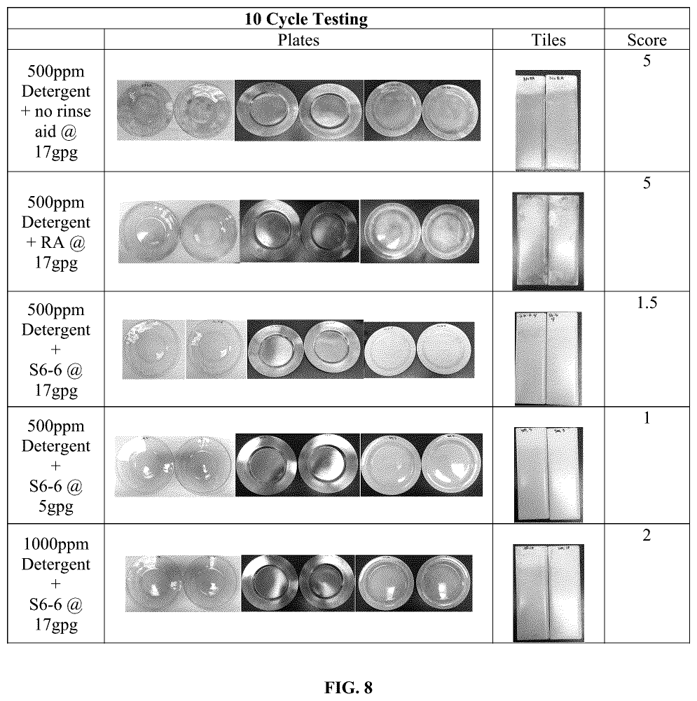

The results of the cleaning efficacy are shown in FIGS. 7 and 8, which show the scoring of the rinse aid compositions of Table 11 post-stain. FIG. 8 compares S6-6 at 17 gpg and 5 gpg with 500 ppm of detergent and 1000 ppm of detergent at 17 gpg with no rinse aid and Ultra Dry.

The cleaning efficacy of the rinse aid compositions of Table 11 were evaluated using a 50 cycle redeposition experiment for ware wash detergents on white ceramic tiles, as described in Example 4. The results are shown in FIG. 9, which show the scoring of the rinse aid compositions of Table 11 post-stain.

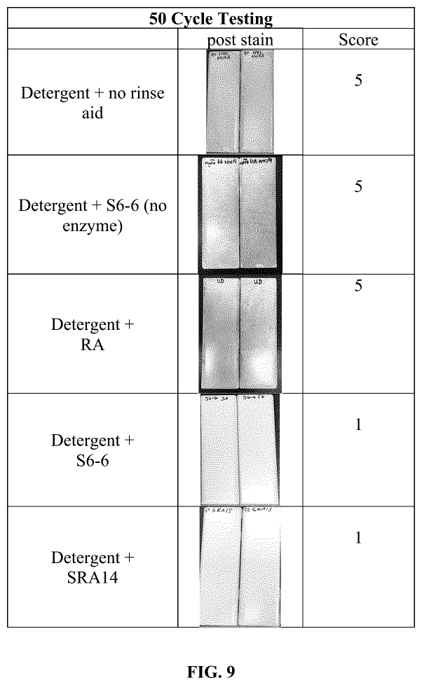

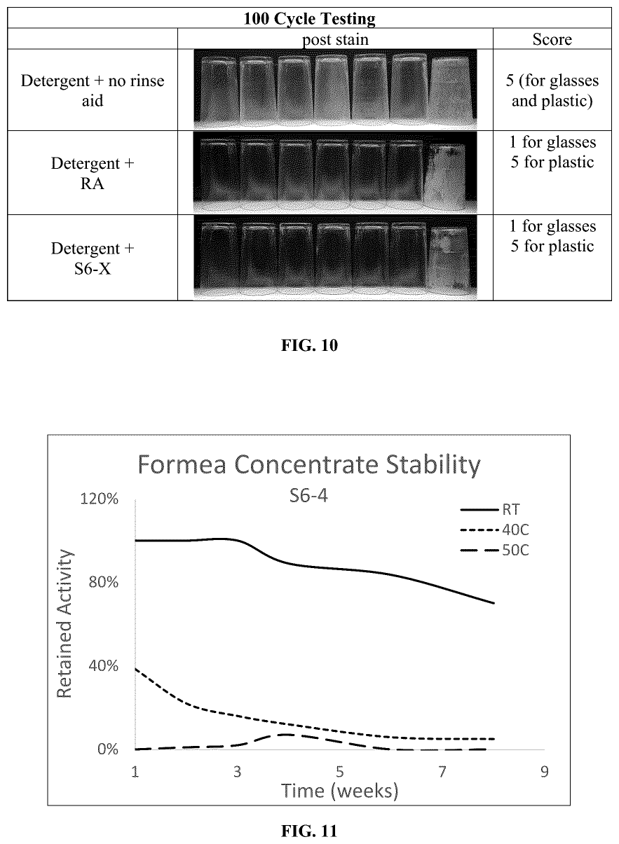

The cleaning efficacy of the rinse aid compositions of Table 11 were evaluated using a 100 cycle testing for glasses and plastic cups run in the presence of detergent and rinse aids for 100 cycles to assess scaling on the glasses to test the ability of compositions to clean glass. 6-10 oz. Libby heat resistant glass tumblers and 1 plastic tumbler were used. The tumblers were cleaned prior to use. After filling the dish machine with 500 ppm of detergent and 17 grain (gpg) water, the heaters were turned on. Testing was conducted in a Hobart AM15 ware wash machine. The wash temperature was adjusted to about 150-160° F. for was and a final rinse temperature was adjusted to about 180-185° F. The detergent concentration was controlled by conductivity. The rinse aid was dosed at 1-2 mL. When the 100 cycles ended, the glasses were allowed to dry overnight. Thereafter they were graded for spots and scaling, or film accumulation (visual). The results are shown in FIG. 10, which show the scoring of the rinse aid compositions Ultra Dry and S6-X and with no rinse aid.

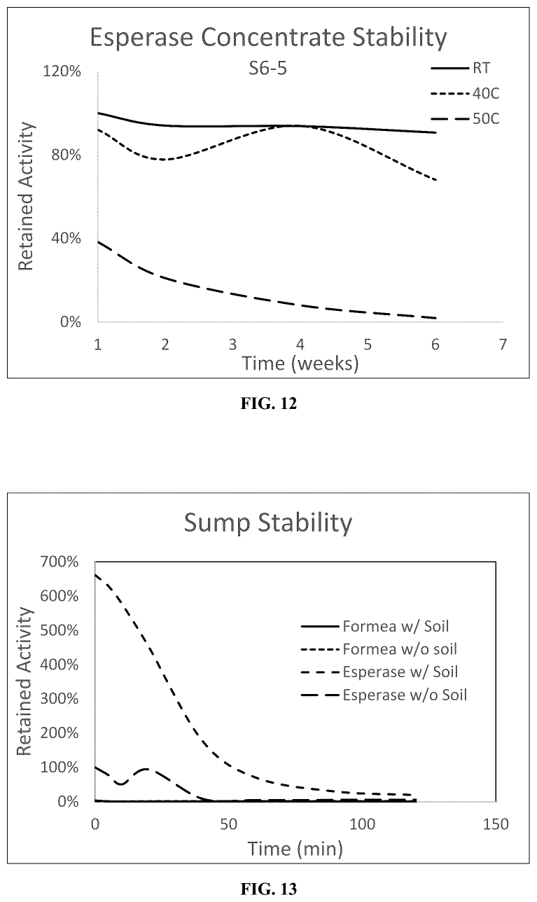

The enzyme stability of S6-4 (the rinse aid composition comprising formea) and S6-5 (the rinse aid composition comprising esperase) were evaluated following a QATM 476 protease assay to determine activity of a proteolytic enzyme in a substrate, as described in Example 1. The compositions were evaluated at room temperature (RT), 40° C., and 50° C. for 6, and 8 weeks. The results of stability are shown in FIGS. 11-12. As shown in both FIGS. 11 and 12, the compositions at room temperature retained the most activity as compared to storage at 40° C. and 50° C. Yet, the esperase stability at 40° C. also retained about 80% of the activity over 6 weeks, with the retained activity being comparable to the room temperature activity at around 4 weeks. This test is to assess stability of the enzyme in the composition once it leaves the rinse arms of the warewash machine.

FIG. 13 shows the sump stability of the formea and esperase rinse aid compositions of Table 11 (S6-4 and 56-5). The sump stability of the compositions was evaluated at 160° F. in the presence of 500 ppm detergent with and without soil present over 120 minutes. As can be seen in FIG. 13, the esperase composition with soil started and retained the most activity over the period of time.

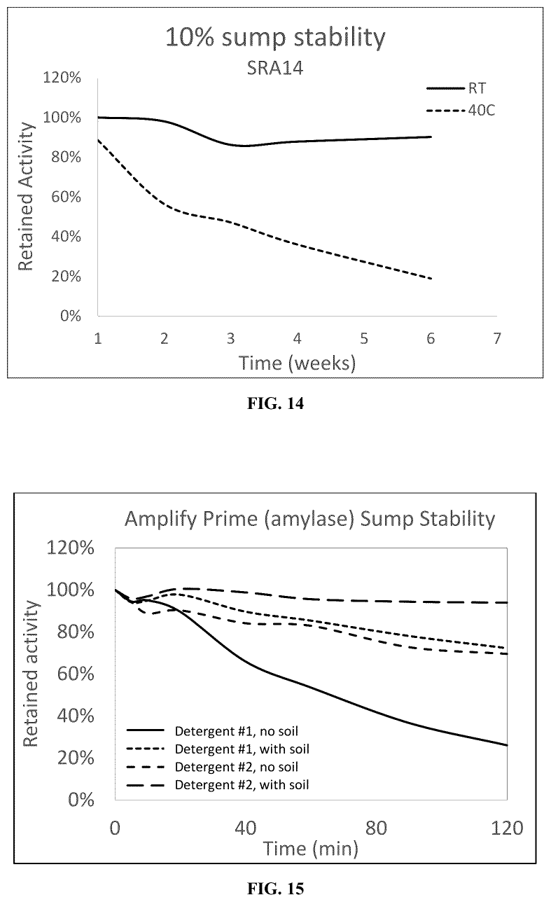

The SRA14 composition of Table 11 were evaluated as a 10% solution at room temperature (RT) and 40° C. for 6 weeks. The results of stability are shown in FIG. 14, which demonstrates that the composition retained almost 100% of its activity at room temperature over the 6 weeks as opposed to only having about 20% retained activity at 40° C.

### Example 6

The sump stability of amylase and protease rinse aid compositions were additionally evaluated similar to the formea and esperase rinse aid compositions of FIG. 13 of Example 5.

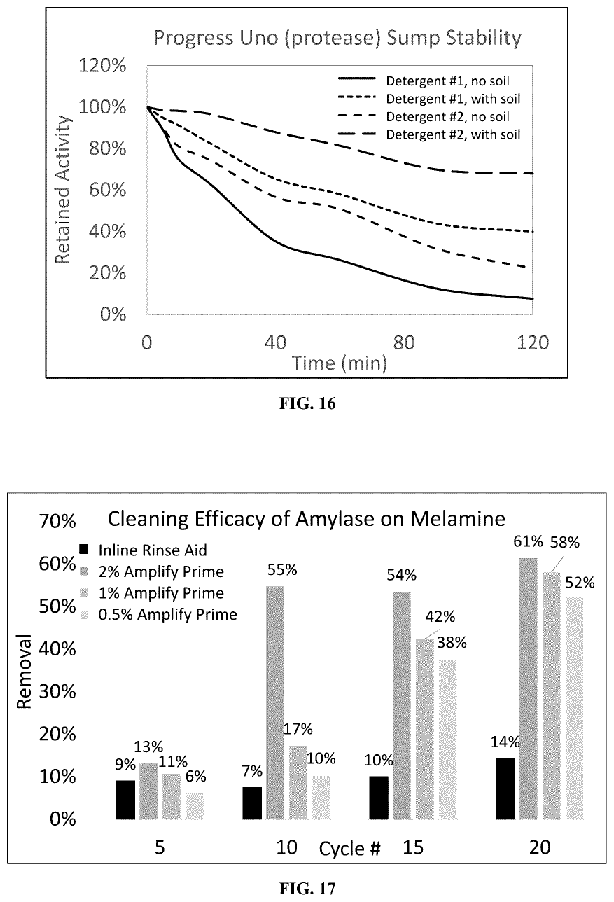

FIG. 15 shows the sump stability of the amylase rinse aid compositions evaluated with an inline detergent composition (detergent #1) against an inline detergent composition that does not contain enzymes (detergent #2). Similarly, FIG. 16 shows the sump stability of protease rinse aid compositions evaluated with detergent #1 against detergent #2. The sump stability of the compositions was evaluated at 160° F. in the presence of 500 ppm of detergent #1 against 1000 ppm of detergent #2 with and without soil present over 120 minutes. As can be seen in both FIGS. 15 and 16 both the amylase and protease rinse aid compositions with soil retained better activity than the detergent #2 with soil.

### Example 7

The cleaning efficacy of various amounts of Amplify Prime (amylase) was evaluated using a 20-cycle testing for melamine tiles run in the presence of detergent and rinse aids for 20 cycles to assess removal of a dyed cornstarch solution to test the ability of compositions to clean melamine. After filling the dish machine with 500 ppm of detergent and 17 grain (gpg) water, the heaters were turned on. Testing was conducted in a Hobart AM15 ware wash machine. The wash temperature was adjusted to about 150-160° F. for wash and a final rinse temperature was adjusted to about 180-185° F. The detergent concentration was controlled by conductivity. The rinse aid was dosed at 1.5 mL. When the 5 cycles, 10 cycles, 15 cycles, and 20 cycles ended, the melamine tiles were allowed to dry. Thereafter they were graded for percent removal of the dyed cornstarch solution. The results are shown in FIG. 17, which show the percent removal results of the 2%, 1%, and 0.5% amylase rinse aid compositions and the inline rinse aid.

### Example 8

The enzyme stability of various rinse aid compositions was evaluated following a QATM 476 protease assay to determine activity of a proteolytic enzyme in a substrate as described in Example 1. The formea and esperase compositions were evaluated as 2% and 5% solutions. The compositions were further evaluated at room temperature (RT), 40° C., and 50° C. for 120 minutes, 2, and 8 weeks.

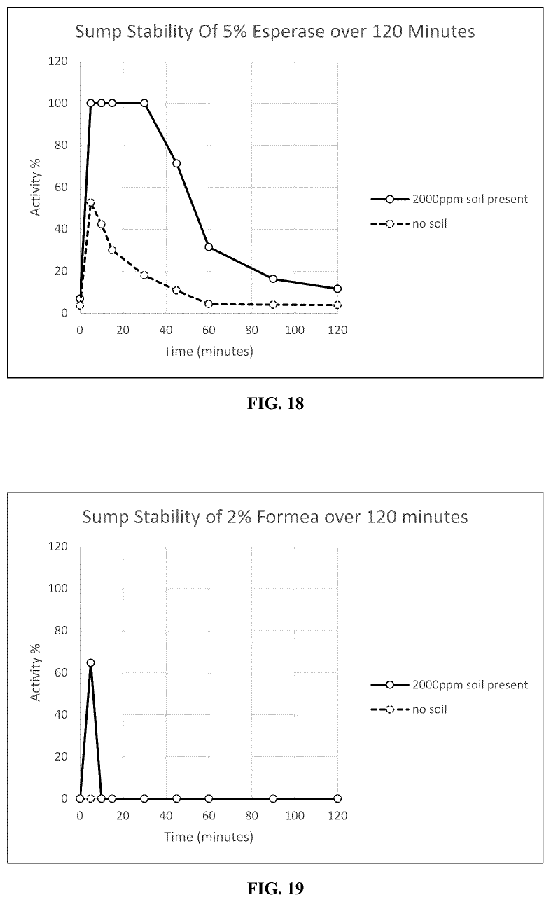

The sump stability of the 5% esperase and 2% formea compositions over 120 minutes is shown in FIGS. 18 and 19. The compositions were evaluated with 2000 ppm of soil present and no soil present. In both FIGS. 18 and 19, the activity of the compositions are higher with soil present than without soil present.

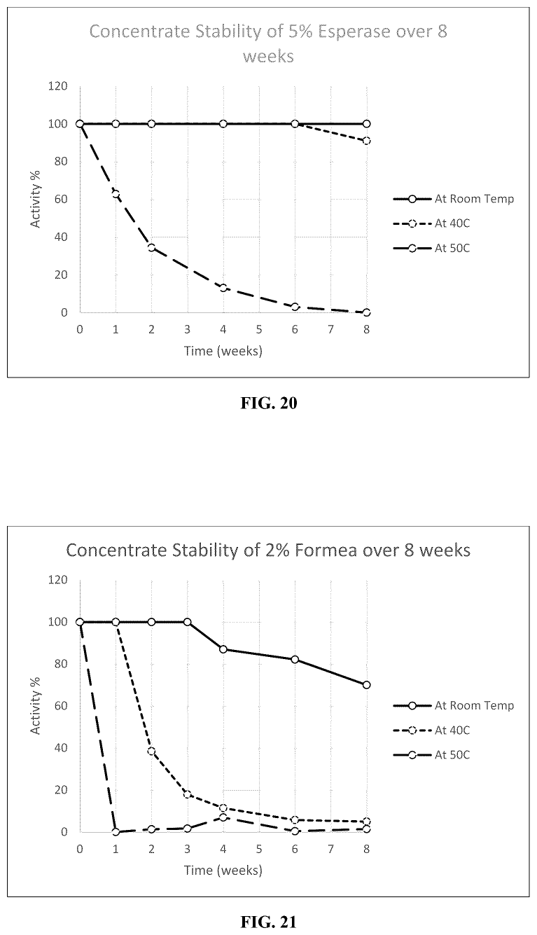

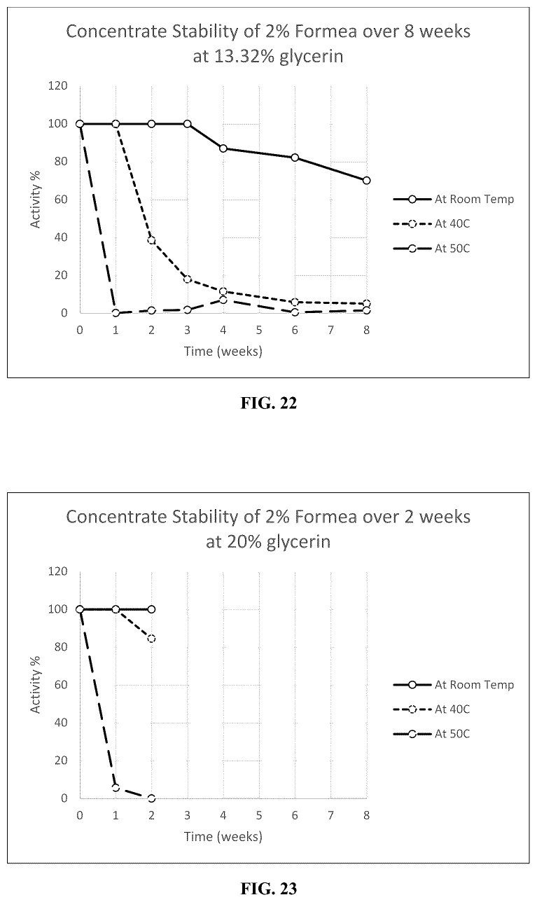

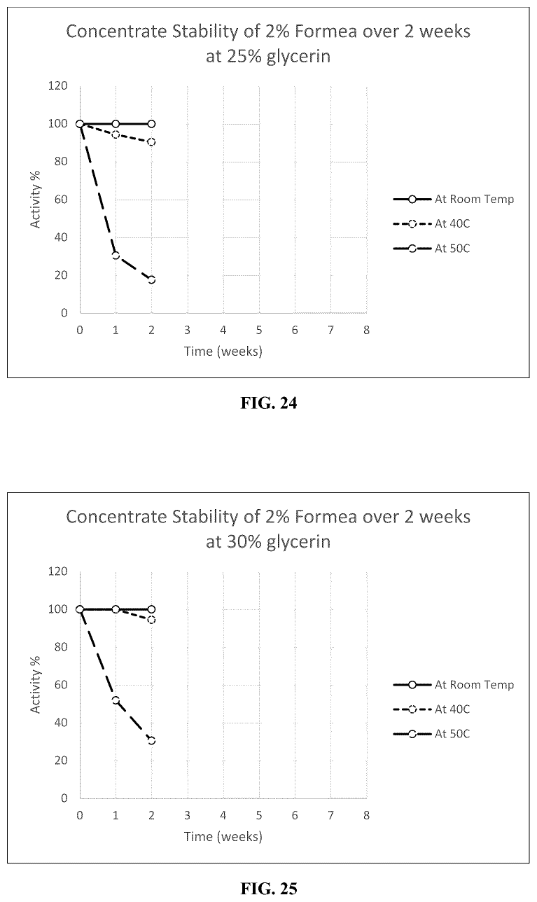

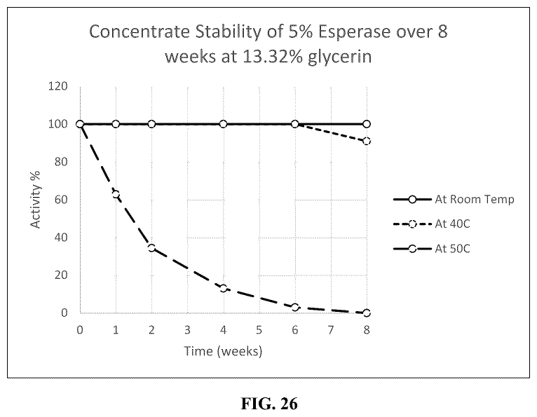

The concentrate stability of the 5% esperase and 2% formea compositions were evaluated at room temperature (RT), 40° C., and 50° C. for 8 weeks. FIGS. 20 and 21 show the results of stability of these compositions. FIGS. 22-25 show 2% formea compositions with various amounts of glycerin (13.32%, 20%, 25%, and 30%) and were evaluated at room temperature (RT), 40° C., and 50° C. for 8 weeks. FIG. 26 shows 5% esperase composition with 13.32% glycerin and evaluated at room temperature (RT), 40° C., and 50° C. for 8 weeks.

### Example 9

Preservative testing in liquid enzymatic rinse aid compositions with NEOLONE™ M10 (CAS 2682-20-4) and KATHON™ CG (CAS 26172-55-4) at two levels were analyzed to demonstrate stability of the preservatives with the compositions to confirm the enzymes are not denatured by a preservative.

The preservatives were selected based on GRAS approval and tested formulations are shown in Table 12.

TABLE 12

| Name | S6-9-1 | S6-9-2 | S6-9-3 | S6-9-4 |
|---|---|---|---|---|
| Water | 37.47 | 37.42 | 37.47 | 37.42 |
| Glycine | 5.00 | 5.00 | 5.00 | 5.00 |
| Glycerin | 13.32 | 13.32 | 13.32 | 13.32 |
| Plurafac SLF 180 | 2.00 | 2.00 | 2.00 | 2.00 |
| Lutensol XL40 | 2.00 | 2.00 | 2.00 | 2.00 |
| Tomadol 91-6 | 2.00 | 2.00 | 2.00 | 2.00 |
| Belclene 200 | 3.00 | 3.00 | 3.00 | 3.00 |
| SXS, 40% | 30.00 | 30.00 | 30.00 | 30.00 |
| NaOH | 2.16 | 2.16 | 2.16 | 2.16 |
| Progress Uno | 2.00 | 2.00 | 2.00 | 2.00 |
| Amplify Prime | 0.50 | 0.50 | 0.50 | 0.50 |
| Lipex Evity 200L | 0.50 | 0.50 | 0.50 | 0.50 |
| Neolone M10 | 0.05 | 0.10 | — | |
| Kathon CG | | | 0.05 | 0.10 |
| | 100.00 | 100.00 | 100.00 | 100.00 |

Samples of the liquid enzymatic rinse aid compositions as described in Table 12 were tested to determine the reduction or inhibition of growth of bacteria, yeast, and mold over 28 days. Bacteria samples were incubated for 3 days at 32° C. Yeast and Mold samples were incubated for 3 days at 26° C. The bacterial inoculum was made up of equal parts of Staphylococcus aureus (ATCC 6538), Escherichia coli (ATCC 11229), Pseudomonas aeruginosa (ATCC 15442), Pluralibacter gergoviae (ATCC 13048), Burkholderia cepacia (ATCC 25416). The yeast/mold inoculum was made up of equal parts of Candida albicans (ATCC 10231) and Aspergillus brasiliensis (ATCC 16404 (formerly Aspergillus niger)).

1 mL of prepared inoculum was added to 99 mL or 99 g of product (or equivalent ratio) to inoculate each sample. The samples were then gently mixed to assure complete mixture of culture within test article. The day of inoculation represents Day 0. The inoculated sample vessels were held at room temperature (about 20-26° C.) during the test period of 28 days. The samples were evaluated initially at Day 0, Day 7, Day 14, Day 21, and Day 28 to determine bacterial growth and yeast/mold growth.

TABLE 13
Bacterial Counts (Log CFU/mL)

| Sample | Day 0 | Day 7 | Day 14 | Day 21 | Day 28 | Pass/ |
|---|---|---|---|---|---|---|
| Number | Sterility | Survivors | Survivors | Survivors | Survivors | Fail |
| S6-9-1 | <1.0 | <1.0 | <1.0 | <1.0 | <1.0 | <1.0 |
| S6-9-2 | <1.0 | <1.0 | <1.0 | <1.0 | <1.0 | <1.0 |
| S6-9-3 | <1.0 | <1.0 | <1.0 | <1.0 | <1.0 | <1.0 |
| S6-9-4 | <1.0 | <1.0 | <1.0 | <1.0 | <1.0 | <1.0 |

TABLE 14
Yeast and Mold Counts (Log CFU/mL)

| Sample | Day 0 | Day 7 | Day 14 | Day 21 | Day 28 | Pass/ |
|---|---|---|---|---|---|---|
| Number | Sterility | Survivors | Survivors | Survivors | Survivors | Fail |
| S6-9-1 | <1.0 | <1.0 | <1.0 | <1.0 | <1.0 | <1.0 |
| S6-9-2 | <1.0 | <1.0 | <1.0 | <1.0 | <1.0 | <1.0 |
| S6-9-3 | <1.0 | <1.0 | <1.0 | <1.0 | <1.0 | <1.0 |
| S6-9-4 | <1.0 | <1.0 | <1.0 | <1.0 | <1.0 | <1.0 |

Tables 13 and 14 show the cleaning efficacy of the liquid enzymatic rinse aid compositions of Table 12. Table 13 shows that the liquid enzymatic rinse aid compositions are effective at minimizing bacterial counts, effectively killing and disinfecting after application and showing no bacterial growth over 28 days after. Similarly, Table 14 shows that the liquid enzymatic rinse aid compositions are also effective at minimizing yeast and mold. These results are passing for all tested organisms demonstrating the evaluated preservatives are compatible with the evaluated compositions.

### Example 10

The stability of esperase and Progress Uno enzymatic rinse aid compositions were evaluated over the course of 8 weeks at room temperature (RT), 40° C., and 50° C. Tables 16-18 show the percent stability of liquid concentrate, solid, and 10% sump rinse aid compositions, respectively.

TABLE 16

| Liquid Concentrate Stability | Esperase | Progress Uno |
|---|---|---|
| 2 wk, RT | 100% | 88% |
| 4 wk, RT | 100% | 88% |
| 8 wk, RT | 99% | 87% |
| 2 wk, 40° C. | 100% | 91% |
| 4 wk, 40° C. | 88% | 91% |
| 8 wk, 40° C. | 71% | 83% |
| 2 wk, 50° C. | 44% | 78% |
| 4 wk, 50° C. | 20% | 65% |
| 8 wk, 50° C. | 3% | 50% |

Table 16 shows that at room temperature, the liquid rinse aid compositions comprising esperase remained more stable than Progress Uno. Only at 50° C. does Progress Uno outperform the stability of the esperase compositions.

TABLE 17

| Solid Stability | Esperase | Progress Uno |
|---|---|---|
| 2 wk, RT | 100% | 100% |
| 2 wk, 40° C. | 102% | 100% |
| 2 wk, 40° C./65% | 60% | 92% |
| 2 wk, 50° C. | 100% | 100% |
| 8 wk, RT | 90% | 99% |
| 8 wk, 40° C. | 100% | 90% |
| 8 wk, 40° C./65% | 38% | 100% |
| 8 wk, 50° C. | 100% | 93% |

Table 17 shows that the solid rinse aid compositions comprising esperase and Progress Uno similarly perform at room temperature, 40° C., and 50° C. at both 2 weeks and 8 weeks. Only at 65% did Progress Uno maintain above a 90% stability when the esperase composition showed 65% stability at 2 weeks and 38% stability at 8 weeks.

TABLE 18

| 10% Sump Stability | Esperase | Progress Uno |
|---|---|---|
| 0 wk | 106% | 100% |
| 4 wk, RT | 56% | 99% |
| 4 wk, 40° C. | 1% | 87% |
| 4 wk, 50° C. | 0% | 41% |
| 8 wk, RT | 35% | 95% |
| 8 wk, 40° C. | 0% | 77% |
| 8 wk, 50° C. | 0% | 24% |

Table 18 shows the Progress Uno rinse aid compositions outperform the esperase rinse aid compositions at 10% sump stability except initially at 0 weeks. These results demonstrate both protease enzymes have desirable stability in the evaluated formulations.

It is to be understood that while the disclosure has been described in conjunction with the detailed description thereof, the foregoing description is intended to illustrate, and not limit the scope of the disclosure, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the disclosure in diverse forms thereof.

1. A rinse aid composition comprising:
at least one enzyme;
optionally a phosphonate, chelant, and/or non-phosphorus stabilizing agent;
at least one nonionic surfactant; and
water and at least one solvent and/or carrier for a neutral liquid composition; or
at least one solidification agent and/or carrier for a neutral solid composition.

2. The composition of claim 1, wherein the composition is a liquid and comprises from about 0.1 wt-% to about 5 wt-% enzyme, from about 0 wt-% to about 5 wt-% phosphonate, from about 1 wt-% to about 20 wt-% nonionic surfactant, and from about 20 wt-% to about 90 wt-% water and the at least one solvent.

3. The composition of claim 1, wherein the at least one solvent is a polyol comprising propylene glycol and/or glycerin.

4. The composition of claim 1, wherein the composition is a solid and comprises from about 1 wt-% to about 10 wt-% enzyme, from about 1 wt-% to about 10 wt-% phosphonate, from about 1 wt-% to about 50 wt-% nonionic surfactant, from about 10 wt-% to about 80 wt-% solidification agent.

5. The composition of claim 4, wherein the solidification agent is a neutral system comprising short-chain alkylbenzene sulfonate, alkyl naphthalene sulfonate, urea, an amide or an alkylamide, polyethylene glycol (PEG), solid EO/PO block copolymer, neutral inorganic salts, or combinations thereof.

6. The composition of claim 4, wherein the solid is a pressed solid or an extruded solid.

7. The composition of claim 1, wherein the composition use solution has a pH between about 6 and about 9, or between about 7 and about 9.

8. The composition of claim 1, wherein the phosphonate is aminotri(methylenephosphonate), sodium salt (ATMP), hydroxyethane-1,1-diphosphonic acid (HEDP), 2-phosphonobutane-1,2,4-tricarboxylic acid (PBTC), or combinations thereof.

9. The composition of claim 1, wherein the nonionic surfactant is a polyoxyethylene-polyoxypropylene block copolymer, alcohol alkoxylates, alcohol ethoxylate, low molecular weight EO containing surfactants, or combinations thereof.

10. The composition of claim 1, further comprising one or more buffering agent(s) and/or pH modifier in an amount between about 0.1 wt-% and about 25 wt-% of the composition.

11. The composition of claim 1, wherein the composition comprises GRAS ingredients.

12. The composition of claim 1, further comprising at least one additional functional ingredient, and/or where the composition is substantially-free of alkali metal hydroxide and/or alkali metal carbonate.

13. The composition of claim 1, wherein the enzyme is a protease, esperase, amylase and/or lipase, and/or where the additional functional ingredient is a preservative.

14. (canceled)

15. (canceled)

16. A method of cleaning and rinsing ware comprising:
contacting the ware with an alkaline detergent composition and thereafter contacting the ware with a rinse aid composition according to claim 1; and
rinsing the ware with water;
wherein the use of the rinse aid composition or the detergent and rinse aid system containing an enzyme provide improved soil removal during the rinse step compared to a rinse aid composition or a detergent and rinse aid system that does not include the enzyme.

17. The method of claim 16, wherein the rinse step has an active concentration between about 5 ppm to about 30 ppm enzyme.

18. The method of claim 16, wherein the rinse aid composition is a single use or a multi-use solid composition.

19. The method of claim 16, wherein the pH of the use solution of the rinse aid composition is between about 6 and about 9, or between about 7 and about 9.

20. The method of claim 16, wherein the method is used in an industrial or consumer warewash machine.

21. The method of claim 16, wherein the ware comprises one or more of an eating utensil, a plate, a bowl, a pot, a pan, or glassware, and wherein the ware is glass, plastic, ceramic, and/or metal.

22. (canceled)

23. The method of -claim 16, wherein the step of rinsing the ware with water is at a temperature between about 70° C. and about 190° C., or for low temperature rinsing at a temperature between about 50° C. and about 85° C.
